(19) United States
(12) Patent Application Publication
(10) Pub. No.: US 2023/0407496 A1
(43) Pub. Date: Dec. 21, 2023

(54) METAL-PEPTOIDS ELECTROCATALYSTS

(71) Applicant: Technion Research & Development Foundation Limited, Haifa (IL)

(72) Inventors: Galia MAAYAN, Haifa (IL); Guilin RUAN, Haifa (IL)

(73) Assignee: Technion Research & Development Foundation Limited, Haifa (IL)

(21) Appl. No.: 18/208,560

(22) Filed: Jun. 12, 2023

Related U.S. Application Data
(60) Provisional application No. 63/366,502, filed on Jun. 16, 2022.

(51) Int. Cl. C25B 11/048; C25B 1/04; C07F 15/06; C07F 13/00; C07F 1/08

(52) U.S. Cl. CPC C25B 11/048; C25B 1/04; C07F 15/065; C07F 13/005; C07F 1/08

(57) ABSTRACT

The invention provides metal-peptoid complexes for use as electrocatalyst in water oxidation processes.

### TECHNOLOGICAL FIELD

The invention generally contemplates electrocatalysts and uses thereof.

### BACKGROUND OF THE INVENTION

Water splitting is an important process towards the generation of hydrogen gas as a renewable and sustainable energy source. The first step in this process, water oxidation, however, is characterized by slow kinetics with multiple bond rearrangements, 2H₂O→O₂+4H⁺+4e⁻ (E°=1.23 V−0.059 pH). Thus, developing efficient electrocatalysts and photocatalysts to lower the energetic barriers for this reaction is one of the most important challenges in catalysis. In nature, this transformation is triggered by the oxygen-evolving complex in photosystem II (OEC-PSII), exploiting solar energy to drive electrons and protons transfer. Inspired by the rules of OEC, the design of water oxidation catalysts (WOCs) has been recently centered on earth-abundant transition metals, such as Mn, Fe, Co, Ni and Cu. Among them, Cu-based WOCs show better stability during homogeneous catalysis, but their activity is mostly limited to low turnover frequency (TOF), and/or high overpotential (η), and/or high pH conditions.

The first reported example of Cu-based WOCs for homogeneous electrocatalysis, a Cu-bipyridine, shows high TOF of about 100 s⁻¹, but requires pH>12 to maintain the active in-situ species, leading to high η. Soon after, the use of bipyridine/isopropyl pyridine ligands equipped with —OH groups, was found to facilitate the oxidation of Cu^{II} center by stabilizing the high oxidation state, thus leading to lower η, compared to Cu-bipyridine in similar high pH conditions. To improve the catalytic activity and enable it at a milder pH, a dinuclear polypyridine complex was designed, demonstrating catalytic activity at pH 7 with increased TOF. It was suggested that this catalyst proceeds via cooperative interaction between the two Cu^{III} centers rather than via high oxidation state Cu^{IV} in a mononuclear Cu center, resulting in the increased catalytic activity. Nevertheless, high η was still required to achieve a better turnover number (TON).

Another effort to use a Cu-based electrocatalyst at mild pH conditions involved use of a buffer solution as a co-catalyst in combination with CuSO₄ without an additional supporting ligand. This involves the coordination of borate species to Cu, leading to electrocatalytic water oxidation at neutral pH, albeit with slow kinetics and high η. To date, the use of the non-innocent borate buffer in homogeneous Cu-based electrocatalytic systems was not studied further.

In attempts to address the slow kinetics of Cu-based WOCs, Cu(peptide) mononuclear complexes were prepared and were shown to act as electrocatalysts with high TOF values. However, as the peptide backbone is significantly unstable toward oxidation reactions and relies on high pH conditions for desired metal coordination, the development of peptides and proteins-bound complexes as water oxidation catalysts is limited.

Peptoids, N-substituted glycine oligomers, can be generated efficiently by the “sub-monomer” solid-phase method, which employs primary amines rather than amino acids, thus enabling the incorporation of various side chains, including catalysts and metal-binding ligands, in a specific manner. The ease of peptoid synthesis, their inherent modularity and their high stability in various pH and oxidative conditions allow the development as efficient catalysts. Peptoids having catalytic sites and non-catalytic sites, which act as a second coordination sphere mimic facilitates intramolecular cooperativity between the catalytic groups and enables very efficient oxidative transformations, such as the conversion of alcohols to aldehydes and imines, and the electrocatalytic oxidation of water. The latter example describes efficient intramolecular cooperative electrocatalytic water oxidation by a peptoid trimer, BPT, bearing 2,2′-bipyridine (BPy)-based Cu complex at the C-terminus, ethanolamine in the respective position and a noncatalytic benzyl group. This mononuclear WOC is highly stable during electrocatalysis, however, like other reported Cu-based electrocatalysts, it requires high pH and high η in phosphate buffer for its activity.

### GENERAL DESCRIPTION

Water electrolysis is a promising approach towards low-cost renewable fuels; however, the high overpotential and slow kinetics limit its applicability. The inventors of the invention disclosed herein have demonstrated the ability of peptoids—N-substituted glycine oligomers—to stabilize high-oxidation state metal ions and form self-assembled di-copper-peptoid complexes. Herein a unique class of metal-peptoids (metallopeptoid or metal-peptoid complex) is disclosed. The metal peptoids of the invention, which may be formed of any metal, e.g., Cu-peptoid duplex, Cu₂(BEE)₂, have been found fast and stable homogeneous electrocatalyst for water oxidation in a borate buffer, at basic pH values, such as 9.35, with low overpotential and high turnover frequency of 129 s⁻¹ (peak current measurements) or 5503 s⁻¹ (FOWA). Both values are the highest reported for Cu-based water electrocatalysts to date.

Cu₂(BEE)₂, as an exemplary system of the invention disclosed herein, was characterized by single-crystal X-ray diffraction and various spectroscopic and electrochemical techniques, demonstrating its ability to maintain stable in 4 cycles of controlled potential electrolysis, leading to a high overall turnover number of 51.4 in a total of 2 hours. Interestingly, the catalytic activity of control complexes having only one ethanolic side chain was 2 orders of magnitudes lower than that of Cu₂(BEE)₂. Based on this comparison and on mechanistic studies, it is proposed that the ethanolic side chains and the borate buffer have significant roles in the high stability and catalytic activity of Cu₂BEE₂; the —OH groups facilitate protons-transfer while the borate species enables oxygen transfer towards O—O bond formation.

By using the newly designed peptoid ligand BEE, as an exemplary peptoid of the invention, the technology was extended to other peptoid systems ligating a variety of metal atoms.

Thus, in a first of its aspects, the invention provides a metal-peptoid complex comprising at least one metal ion associated to a peptoid oligomer comprising at least one metal-binding ligand and at least one proton acceptor group, the metal-peptoid complex being optionally adapted for use as a catalyst or an electrocatalyst.

Further provided is a catalyst or an electrocatalyst in a form of a metal-peptoid complex comprising at least one metal ion associated to a peptoid oligomer comprising at least one metal binding ligand and at least one proton acceptor group.

The invention further provides a metal-peptoid complex having an organic chain and at least one metal ion associated therewith, wherein the organic chain being of a structure A-B, wherein A is at least one metal-binding ligand and B is at least one proton acceptor group, wherein A and B are associated via an amide bond, or a linker spacer comprising one or more organic functionalities.

In some embodiments, a compound of structure A-B is of the structure A-(X)n-B, wherein A and B are as defined, X is glycine or a substituted form thereof and n is an integer between 1 and 15.

In some embodiments, each of A and B are N-substituted glycine units, wherein A is an N-substituted glycine wherein substitution is by at least one metal-binding ligand, and wherein B is an N-substituted glycine wherein substitution is by a proton acceptor group.

The “metal-peptoid complex” of the invention is an N-substituted alpha-, beta- or gamma-peptoid oligomer, composed of 2 or more primary amines. The peptoid structure may be linear, acyclic or cyclic. In some embodiments, the peptoid is formed of primary amines or primary amines and alpha amino acids, and may be a N-substituted glycine oligomer comprising between 2 and 15 glycine units which are N-substituted to provide metal association with at least one metal ion. Unlike peptides, peptoid structures of the invention comprise N-substitution and may or may not comprise a substitution at any of the α-carbons (see FIG. 1).

As depicted in FIG. 1, a peptoid may comprise 2 or more repeating N-substituted glycine units, such that n may be between 0 and 13. Substituent R provided on the nitrogen atoms may be selected amongst metal binding ligand groups and proton acceptor groups, as further defined herein. The R substituents may alternatively or additionally be selected amongst functionalities which may contribute to the stability of the peptoid structure, to its chemical interaction with the metal atom, to charge distribution in the peptoid, to the peptoid 3D wrapping around the metal atom or generally to any other feature of the peptoid. Thus, substituent R may further or alternatively be selected amongst alkyl groups, alkenyl groups, alkynyl groups, cycloalkyl groups, aryl groups, aralkyl groups, electro-withdrawing groups, electro-donating groups, bulky groups and single atom groups such as H and halides.

As used herein, alkyl, alkenyl and alkynyl groups contain between 1 and 10 carbon atoms, or 1 or 2 to 10 carbon atoms, and are straight or branched. Alkenyl carbon chains contain between 2 and 10 carbon atoms, in certain embodiments, between 1 and 3 double. Alkynyl carbon chains contain between 2 and 10 carbon atoms, in some embodiments, between 1 and 3 triple bonds. Exemplary alkyl, alkenyl and alkynyl groups include, for example, methyl, ethyl, propyl, isopropyl, isobutyl, n-butyl, sec-butyl, tert-butyl, isohexyl, propenyl and propargyl moieties.

As used herein, the “cycloalkyl group” is a saturated mono- or multi-cyclic ring system, having between 3 and 10 carbon atoms, or 5 or 6 carbon atoms. The ring system may be composed of one ring or two or more rings which may be joined together in a fused, bridged or spiro-connected fashion.

As used herein, the “aryl group” is an aromatic monocyclic or multicyclic group containing from 6 to 10 carbon atoms. Aryl groups include substituted or unsubstituted fluorenyl, phenyl, and naphthyl.

The “aralkyl” group refers to an alkyl group in which one of the hydrogen atoms of the alkyl is replaced by an aryl group.

The electro-withdrawing group may be any such group as known in the field and including, in a non-limiting manner nitro, trifluoromethyl, perfluoroethyl, esters, ketones and carboxylic acids, as well as nitrile and halogens.

The electro-donating group may be any such group as known in the field and including, in a non-limiting manner alkyl, hydroxyls and amino groups.

Bulky groups are groups which provide steric bulk by having a size at least as large as a methyl group. In some embodiments, the bulky group comprises a ternary or quaternary carbon.

Single atom groups may be selected amounts terminal atoms such as H and halides such as I, Br, Cl and F.

The number of N-substituted glycine monomers and the selection/number of substituents present at the N positions may determine the peptoid ability to coordinate one or more metal ions. The selection and number of the N-substituted monomers may thus have an effect on the length, molecular weight and other properties of the metal-chelating peptoid and also on the peptoid stability under varying oxidation potentials and pH.

To maintain stability under varying oxidation potentials and pH, peptoids of the invention may comprise between 2 and 15 N-substituted glycine units. In some embodiments, the number of N-substituted glycine monomers is 2, 3, 4, 5, 6, 7, 8, 9, or 10. In some embodiments, the peptoid is a tripeptoid, a tetrapeptoid or a pentapeptoid.

The peptoid may be structured to chelate a single metal atom or may be structured as a duplex or a triplex, chelating 2 or 3 metal ions, respectively. Other more complex systems may also be formed and used as disclosed herein.

The at least one metal binding ligand may be any functionality comprising one or more nitrogen-containing heteroaryl group. Such may be selected from 5-membered ring N-containing heteroaryl groups and 6-memembred ring N-containing heteroaryl groups, which may be monocyclic or multicyclic or fused ring systems. Non-limiting examples include pyridinyl, pyridazinyl, pyrrolyl, pyrimidinyl, pyrazolyl, imidazolyl, indazolyl, indolyl, quinolinyl, isoquinolinyl, and others.

In some embodiments, the metal binding ligand is a multicyclic e.g., biaryl or fused form, of any of the aforementioned N-containing heteroaryl.

In some embodiments, the metal binding ligand is an N-containing heteroaryl selected from pyridinyl, multicyclic pyridinyl and fused structures of pyridinyl. In some embodiments, the metal binding group is pyridinyl or bipyridinyl or terpyridinyl.

In some embodiments, a peptoid of the invention comprises a metal binding ligand derived from 2,2′-bipyridine, 4′-substituted-2,2′:6′,2″-terpyridine, 2-picolylamine, and dipicolyl amine.

In some embodiments, the metal binding group is associated to an N atom of the peptoid structure via a short linker moiety which may comprise one or more carbon atoms. Typically, the metal binding group is associated to an N atom of the peptoid structure via one or two carbon groups (e.g., —CH₂—, ═CH—, C) which may optionally comprise a heteroatom such as O, N or S. In some embodiments, the metal binding group is associated to an N atom of the peptoid structure via a linker group having the structure —(CH₂)ₘ—Xₖ—, wherein m is an integer between 1 and 3, X is a heteroatom selected from N, O and S and k is 0 or 1. In some embodiments, the metal binding group is associated to an N atom of the peptoid structure via a group selected from —CH₂—CH₂—, —CH₂—CH₂—O—, —CH₂—, —CH₂—O—, —CH₂—CH₂—NH—, —CH₂—CH₂—N— and —CH₂—CH₂—N(CH₂—)₂.

In some embodiments, the metal binding group is pyridinyl or bipyridinyl or terpyridinyl. In some embodiments, each of the pyridinyl, the bipyridinyl, or the terpyridinyl may be associated to the peptoid structure via a group selected from —CH₂—CH₂—, —CH₂—CH₂—O—, —CH₂—, —CH₂—O—, —CH₂—CH₂—NH—, —CH₂—CH₂—N— and —CH₂—CH₂—N(CH₂—)₂.

Exemplary metal binding groups are shown in FIG. 2, wherein the dashed line designates a point of connectivity to N atom of a glycine unit.

The at least one proton acceptor group is capable of associating or coordinating with a hydrogen cation. The proton acceptor group may comprise any atom regarded as a base, such including oxygen atoms, nitrogen atoms and sulfur atoms.

In some embodiments, the proton acceptor group may be selected amongst groups containing hydroxyl functionalities and amine functionalities.

The proton acceptor groups may be associated to an N atom of a peptoid structure via a short linker moiety which may comprise one or more carbon atoms. The proton acceptor group may be associated to an N atom of the peptoid structure via one or two carbon groups (e.g., —CH₂—, ═CH—, C) which may comprise the acceptor group as an end group and/or as a group substituted along the linker moiety. In some embodiments, the proton acceptor group is associated to an N atom of the peptoid structure via an alkylene which may be branched or linear and which may have one or more acceptor groups associated therewith. In some embodiments, the proton acceptor group is associated to an N atom of the peptoid structure via an alkylene group selected from —CH₂—CH₂—, —CH₂—, —CH(CH₂—)₂, —CH₂—CH—CH₂— and others.

In some embodiments, the proton acceptor group is a hydroxyl group or an amine group that is associated to the peptoid structure via a group selected from ethylene (—CH₂—CH₂—), methylene (—CH₂—), isopropylene (—CH(CH₂—)₂) and propylene (—CH₂—CH—CH₂—). In some embodiments, the proton acceptor group comprises 1 or 2 or 3 hydroxyl and/or amine groups.

Some non-limiting examples of proton acceptor groups are shown in FIG. 3, wherein the wiggly line designates a point of connectivity to an N atom of a glycine unit.

In some embodiments, a peptoid structure of the invention may comprise at least one metal binding ligand and at least one proton acceptor groups, wherein the at least one metal binding ligand is selected amongst pyridinyl and the ligands shown in FIG. 2 (Bipy, Terpy, DiPi and Pico) and the at least one proton acceptor group is selected from ethanol-yl and the groups shown in FIG. 3 (PA1, PA2 and PA3).

In some embodiments, a peptoid of the invention comprises a metal binding ligand derived from 2,2′-bipyridine, 4′-substituted-2,2′:6′,2″-terpyridine, 2-picolylamine, and dipicolyl amine, and comprises at least one proton acceptor group derived from ethanol, 1,3-dihydroxypropanol, 1,2-dihydroxypropanol and ethylamine.

In some embodiments, a peptoid comprises one or two metal binding ligands, as defined and selected, and one or two proton acceptor groups, as defined and selected.

Peptoids of the invention are structured to associate or chelate or bind at least one metal atom. The metal atom being a metal ion in a valency according to the specific atom. The association between the metal binding ligand and the metal atom may be coordination or may involve any other or any one or more association. In some cases, the association is non-innocent.

The metal atom may be selected amongst copper atoms (Cu⁺¹ and Cu⁺²), cobalt (Co⁺², Co⁺³), manganese (Mn⁺², Mn⁺³, Mn⁺⁴, Mn⁺⁵, Mn⁺⁶), nickel (Ni⁺², Ni⁺³), iron (Fe⁺², Fe⁺³, Fe⁺⁴), ruthenium (Ru⁺², Ru⁺³, Ru⁺⁴), rhodium (Rh⁺², Rh⁺³, Rh⁺⁴), iridium (Ir⁺², Ir⁺³, Ir⁺⁴) and others.

In some embodiments, metal-peptoid complexes of the invention comprise a metal chelated or associated to the peptoid via the metal bonding ligand(s), as defined herein. The metal, which may be a single atom or two or more atoms, may be selected from any metal atom capable of oxidation of a substrate material. Such metal atoms may be, for example, copper atoms (Cu⁺¹ and Cu⁺²), cobalt (Co⁺², Co⁺³), manganese (Mn⁺², Mn⁺³, Mn⁺⁴, Mn⁺⁵, Mn⁺⁶) nickel (Ni⁺², Ni⁺³), iron (Fe⁺², Fe⁺³, Fe⁺⁴), ruthenium (Ru⁺², Ru⁺³, Ru⁺⁴), rhodium (Rh⁺², Rh⁺³, Rh⁺⁴), and iridium (Ir⁺², Ir⁺³, Ir⁺⁴).

In some embodiments, the peptoid is any one of:

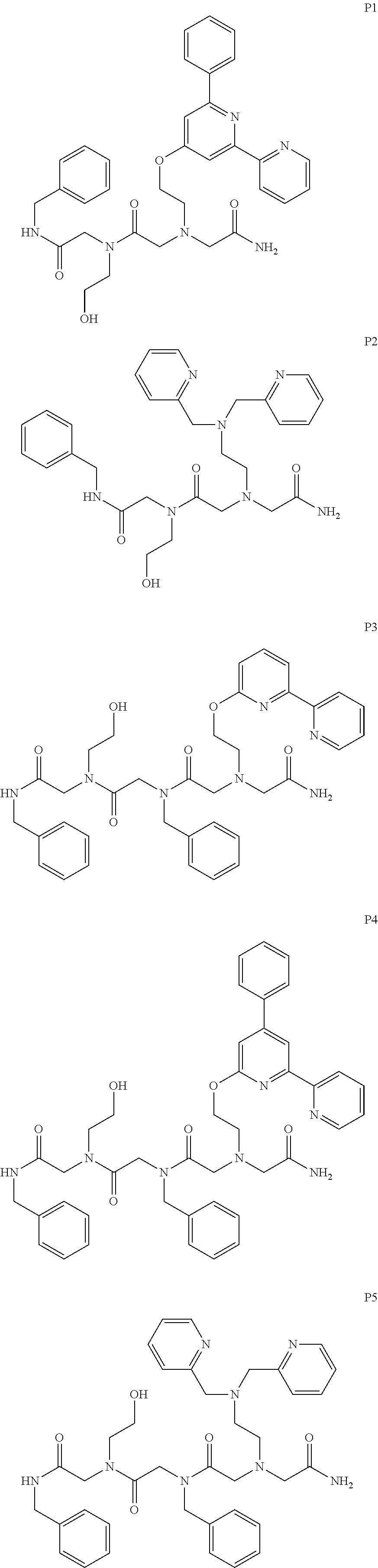 [SMILES: NC(=O)CN(CCOc1cc(-c2ccccc2)nc(-c2ccccn2)c1)CC(=O)N(CCO)CC(=O)NCc1ccccc1 ; NC(=O)CN(CCN(Cc1ccccn1)Cc1ccccn1)CC(=O)N(CCO)CC(=O)NCc1ccccc1 ; NC(=O)CN(CCOc1cccc(-c2ccccn2)n1)CC(=O)N(CC(=O)N(CCO)CC(=O)NCc1ccccc1)Cc1ccccc1 ; NC(=O)CN(CCOc1cc(-c2ccccc2)cc(-c2ccccn2)n1)CC(=O)N(CC(=O)N(CCO)CC(=O)NCc1ccccc1)Cc1ccccc1 ; NC(=O)CN(CCN(Cc1ccccn1)Cc1ccccn1)CC(=O)N(CC(=O)N(CCO)CC(=O)NCc1ccccc1)Cc1ccccc1]

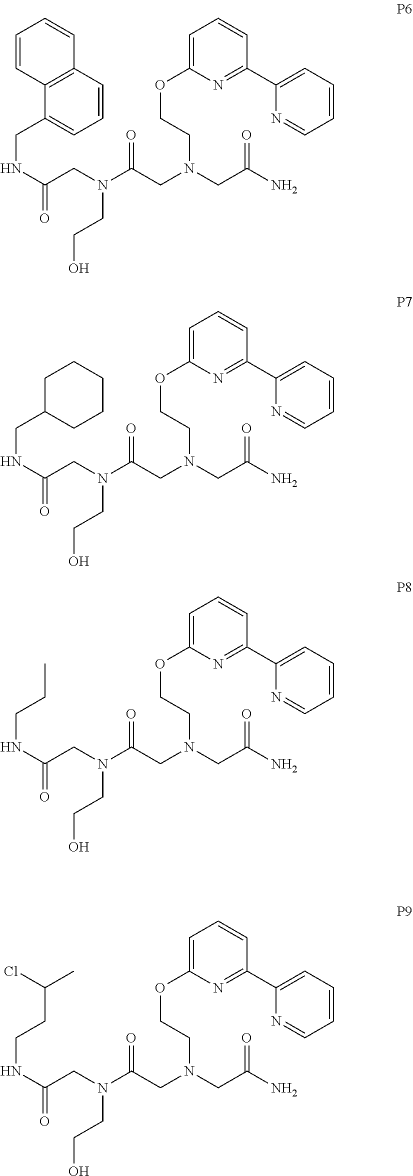 [SMILES: NC(=O)CN(CCOc1cccc(-c2ccccn2)n1)CC(=O)N(CCO)CC(=O)NCc1cccc2ccccc12 ; NC(=O)CN(CCOc1cccc(-c2ccccn2)n1)CC(=O)N(CCO)CC(=O)NCC1CCCCC1 ; CCCNC(=O)CN(CCO)C(=O)CN(CCOc1cccc(-c2ccccn2)n1)CC(N)=O ; CC(Cl)CCNC(=O)CN(CCO)C(=O)CN(CCOc1cccc(-c2ccccn2)n1)CC(N)=O]

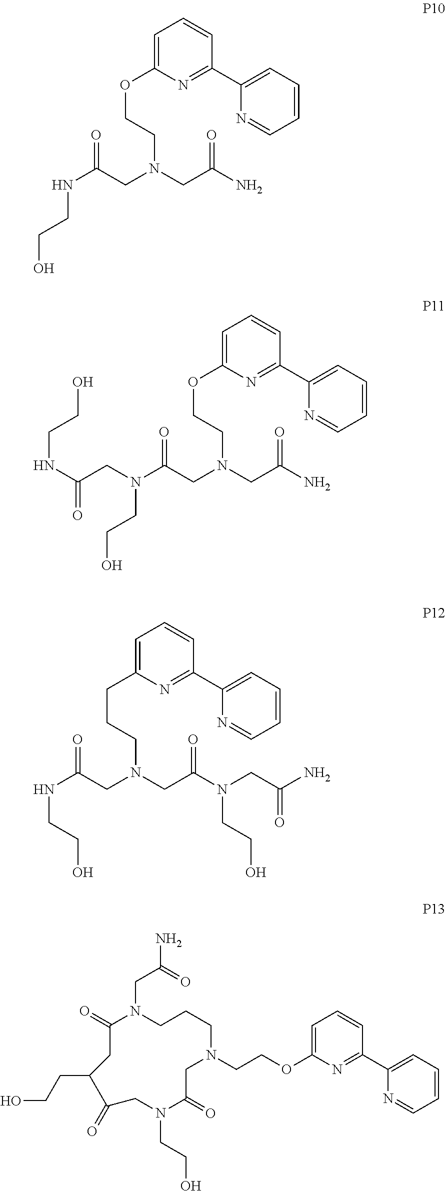 [SMILES: NC(=O)CN(CCOc1cccc(-c2ccccn2)n1)CC(=O)NCCO ; NC(=O)CN(CCOc1cccc(-c2ccccn2)n1)CC(=O)N(CCO)CC(=O)NCCO ; NC(=O)CN(CCO)C(=O)CN(CCCc1cccc(-c2ccccn2)n1)CC(=O)NCCO ; NC(=O)CN1CCCN(CCOc2cccc(-c3ccccn3)n2)CC(=O)N(CCO)CC(=O)C(CCO)CC1=O]

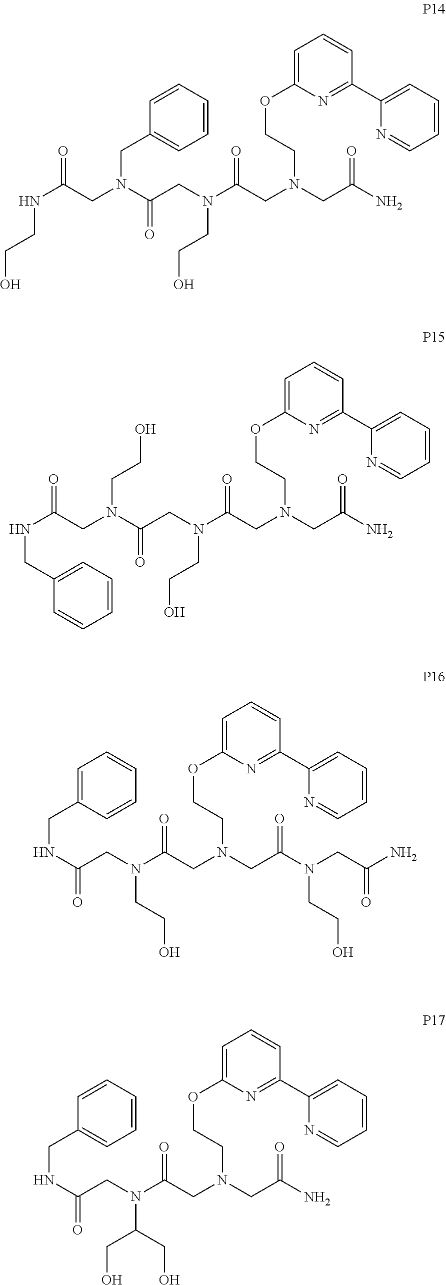 [SMILES: NC(=O)CN(CCOc1cccc(-c2ccccn2)n1)CC(=O)N(CCO)CC(=O)N(CC(=O)NCCO)Cc1ccccc1 ; NC(=O)CN(CCOc1cccc(-c2ccccn2)n1)CC(=O)N(CCO)CC(=O)N(CCO)CC(=O)NCc1ccccc1 ; NC(=O)CN(CCO)C(=O)CN(CCOc1cccc(-c2ccccn2)n1)CC(=O)N(CCO)CC(=O)NCc1ccccc1 ; NC(=O)CN(CCOc1cccc(-c2ccccn2)n1)CC(=O)N(CC(=O)NCc1ccccc1)C(CO)CO]

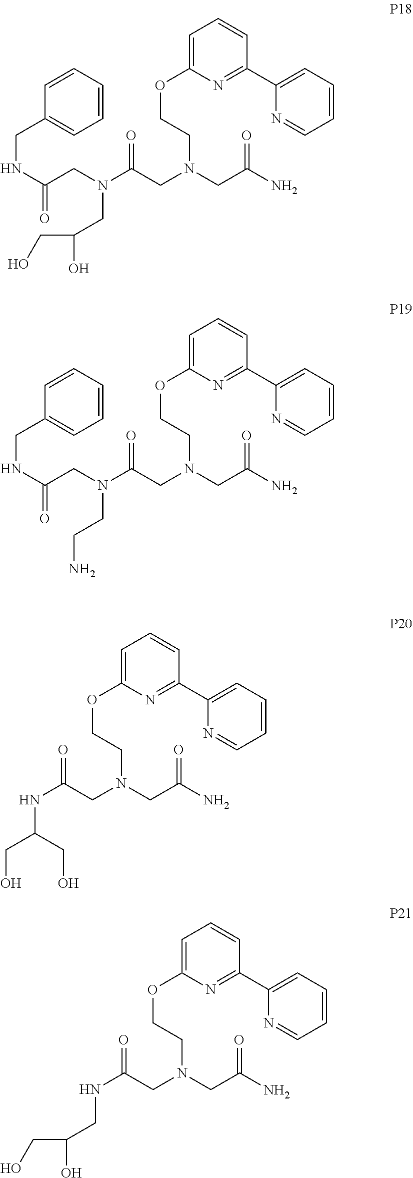 [SMILES: NC(=O)CN(CCOc1cccc(-c2ccccn2)n1)CC(=O)N(CC(=O)NCc1ccccc1)CC(O)CO ; NCCN(CC(=O)NCc1ccccc1)C(=O)CN(CCOc1cccc(-c2ccccn2)n1)CC(N)=O ; NC(=O)CN(CCOc1cccc(-c2ccccn2)n1)CC(=O)NC(CO)CO ; NC(=O)CN(CCOc1cccc(-c2ccccn2)n1)CC(=O)NCC(O)CO]

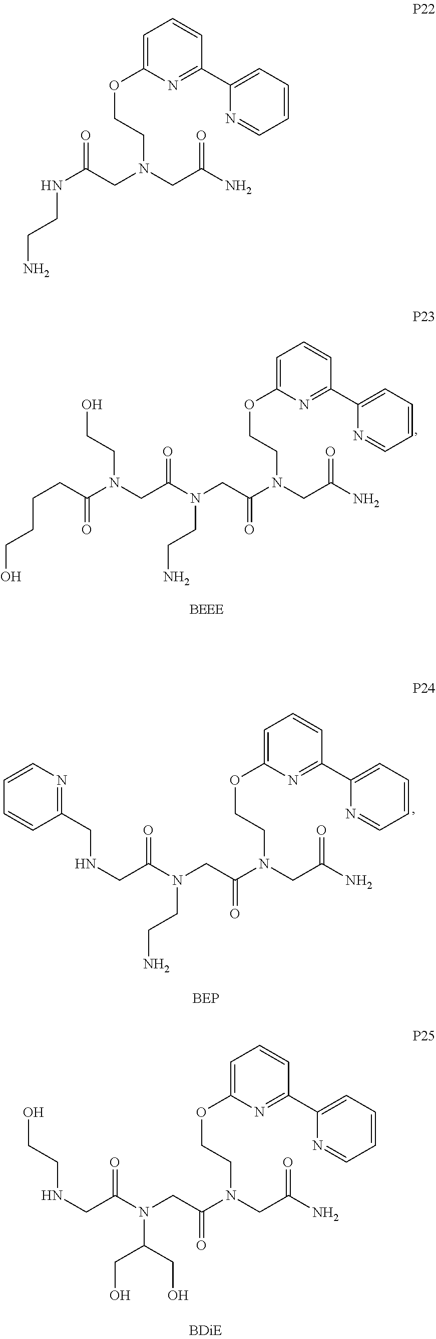 [SMILES: NCCNC(=O)CN(CCOc1cccc(-c2ccccn2)n1)CC(N)=O ; NCCN(CC(=O)N(CCOc1cccc(-c2ccccn2)n1)CC(N)=O)C(=O)CN(CCO)C(=O)CCCCO ; NCCN(CC(=O)N(CCOc1cccc(-c2ccccn2)n1)CC(N)=O)C(=O)CNCc1ccccn1 ; NC(=O)CN(CCOc1cccc(-c2ccccn2)n1)C(=O)CN(C(=O)CNCCO)C(CO)CO]

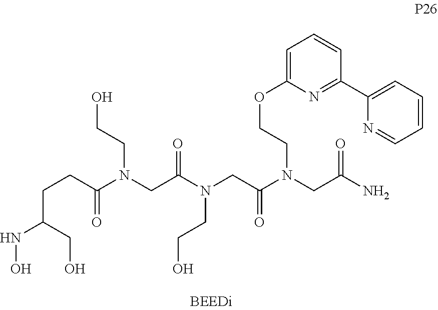 [SMILES: NC(=O)CN(CCOc1cccc(-c2ccccn2)n1)C(=O)CN(CCO)C(=O)CN(CCO)C(=O)CCC(CO)NO]

In some embodiments, any of the peptoid structures disclosed herein is provided as a metal-peptoid complex, wherein the metal is as defined herein. Non-limiting examples include a Cu-peptoid or a Co-Peptoid or a Mn-Peptoid of any of the peptoid structures defined and exemplified herein.

In some embodiments, the peptoid is BEE having the structure:

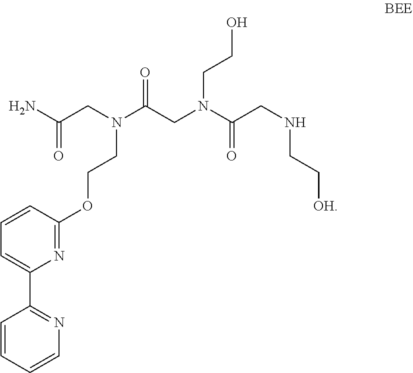 [SMILES: NC(=O)CN(CCOc1cccc(-c2ccccn2)n1)C(=O)CN(CCO)C(=O)CNCCO]

In some embodiments, the metal-peptoid complex is a Cu-BEE complex. The Cu-BEE complex may be represented as a duplex of the structure:

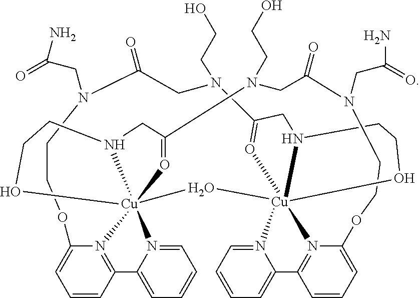

In some embodiments, the peptoid is any of the peptoids herein designated P1 through P26 and metal complexes thereof. In some embodiments, the peptoid is P1 and an exemplary metal complex thereof is the duplex Mn₂(P1)₂ having the structure:

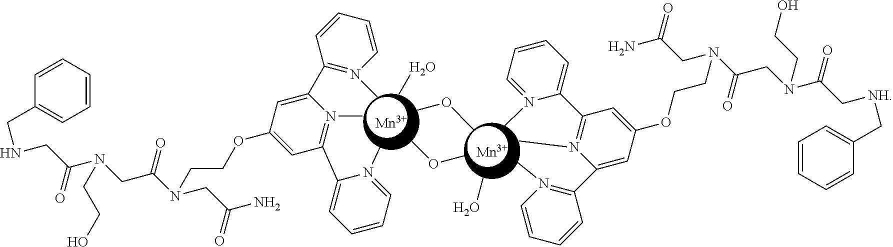

The invention further provides a compound of the structure BEE, as shown herein and metal complexes thereof. In some embodiments, the complex is M(BEE)₁₋₃, wherein M is a metal as defined, associated to one or two or three BEE units.

Further provided is a peptoid selected from any of structures P1 through P26 and metal complexes thereof.

Peptoids of the invention can be efficiently synthesized on solid support, using any methodology known in the art. One exemplary useful method of synthesis is the “submonomer” method shown in FIG. 4. This efficient synthesis employs primary amines and may not require protection and de-protection steps.

Peptoids are chemically inert toward many catalytic transformations and therefore represent a highly versatile scaffold. Moreover, the incorporation of metal centers, such as Mn⁺, within peptoid oligomers facilitates the M₍ₙ₊₁₎⁺/Mn⁺ process, which occurs at a lower potential relative to the oxidation of the same metal centers that are not incorporated within a peptoid sequence. This implies that peptoids can stabilize metal ions in their high oxidation state. The ease of peptoid synthesis, the inherent modularity of peptoids and their high stability in various pH and oxidative conditions allowed the development of peptoids as efficient catalysts.

The metal-binding ligands Bipy, Terpy, Dipi and Pico (FIG. 2), as well as others as disclosed herein, may be introduced to the peptoid backbone via an amine displacement step, as shown in FIG. 4, as primary amines. Although a variety of proton acceptors can be used for the synthesis of the peptoids, simple alcohols and primary amines such as ethanol, propanediol(s) and ethylamine (FIG. 3) may be suited for producing effective peptoid catalysts, because they are relatively good bases and thus can serve as good proton acceptors. Ethylamine may be incorporated via its protected amine derivative N-Boc-ethylenediamine (FIG. 5). Ethanol and propanediol(s) may be incorporated via their silyl-protected amine derivatives that can be synthesized from the corresponding amines in one step (FIG. 6).

Polypyridine-based ligands may also be used for the formation of the metal-peptoid complexes. Terpy analogue TPT, designated herein as P1, as well as BPT, which has a Bipy group instead of the Terpy group (FIG. 7A) were exploited for the formation of Cobalt peptoids to be used as electrocatalysts candidates. As Cobalt can bind two Bipy/Terpy ligands from two different peptoids, Co-based complexes may be prepared in order to obtain an intramolecular Co-complex with one or more free coordination sites for water binding. Mn ions are expected to bind two Bipy or Terpy ligands via oxygen atom(s) (see FIG. 7B) forming the Mn-peptoid complex depicted in FIG. 7C. Examples of peptoids with two metal binding ligands that can be used to stabilize intramolecular binding and form Cobalt-based peptoids and Mn- and Cu-peptoids are designated herein as compounds P2 through P5.

Structure-directing groups are common peptoid side-chains. These side chains may vary in their bulkiness or electronic properties. Non-limiting examples include naphthyl, cyclohexyl, propyl and propyl chloride groups. These may be incorporated within the peptoid sequence instead of a benzyl group (as shown for peptoids P6 through P9). Dimer P10, which does not have a structure-directing group is another peptoid that may be used according to the invention.

BPT or P10 may be further modified to include an additional ethanolic side chain, i.e., an additional —OH group as a proton acceptor, in different positions along the sequence (as shown for peptoids P11 through P16). Among these, the oligomer P13 is a cyclic peptoid designed to enforce a structural constrain that may enable one —OH group and the metal binding ligand to be on the same side of the macrocycle, while the second —OH group is on the other side of the macrocycle. The structural differentiation between the two —OH groups may lead to a functional difference, with the one on the same side of the metal binding ligand acting to stabilize the metal center, and the second acting as a proton acceptor. Peptoid P13 may be derived from P17 utilizing a microwave assisted on-resin cyclization method, based on intramolecular nucleophilic substitution.

The ethanol group(s) within selected peptoid(s), including peptoids P6 through P16 may be further replaced by proton acceptor groups PA1, PA2 or PA3 as shown in peptoids P17 through P26. Cu-based complexes may be prepared in a similar way to Cu(BPT)(OH)₂ in order to obtain mononuclear intramolecular Cu complexes with one or more free coordination sites for water binding. The complexes may be characterized and the oxidation state of their metal centers may be determined as described herein.

BEE, which is a peptoid ligand having one bipyridine and two ethanolic side chains, may be used to construct a dinuclear Cu complex, Cu₂(BEE)₂, that is a highly active electrocatalyst for water oxidation in borate buffer at mild pH and with low Notably, compared with reported Cu-based water oxidation catalysts (WOCs), the turnover frequency (TOF) value of Cu₂(BEE)₂ is dramatically high, reaching 129 s⁻¹ considering the peak current measurements, or 5503 s⁻¹ by foot-of-the-wave analysis (FOWA). This seems to be the highest TOF reported for Cu-based water oxidation electrocatalysts. The experimental turnover number (TON) value is about 52 with >90% Faradaic efficiency in only 2 hours at an overpotential of about 600 mV. It is possible to calculate the kV/h required to produce 1 Kg of H₂ to be about 45, which is 10% lower than what is used in industry today (and 10% higher than the known Grader/Rothchild system). These significant results are attributed to the cooperative interactions between the two Cu sites in combination with the stabilization of the intermediate(s) by the —OH groups and the co-catalytic activity of the borate species from the buffer solution, as supported by our mechanistic studies. Thus, the combination between a metal complex such as di-Cu complex, a peptoid oligomer as a ligand and borate buffer, as co-catalyst, not only creates a completely new catalytic system, but most uniquely the best metal-based e.g., Cu-based system (in terms of both reactivity and stability) ever reported.

Thus, in another aspect there is provided an electrocatalyst comprising or consisting a peptoid or a metal peptoid complex according to the invention.

The invention further provides a solution comprising a peptoid or a metal-peptoid complex according to the invention and a borate species, e.g., as a borate buffer.

Also provided is an electrocatalyst system comprising at least one metal peptoid according to the invention and a borate species.

Also provided is an oxidative aqueous medium comprising a metal-peptoid complex comprising at least one metal ion associated to a peptoid oligomer comprising at least one metal-binding ligand and at least one proton acceptor group, the metal-peptoid complex being optionally adapted for use as a catalyst or an electrocatalyst; and a borate species.

As disclosed herein, metal peptoids are proposed as catalysts in a variety of Redox reactions, allowing for effective oxidation of a variety of substrates, e.g., water. Thus, solutions or media, typically aqueous media, may be regarded as “oxidative aqueous media”, namely capable of oxidizing a substrate material in an aqueous solution comprising the metal peptoid, as a catalyst or an electrocatalyst, and a borate species. Notably, the use of metal peptoids of the invention as electrocatalysts is unlimited in its implementation in a variety of oxidation reactions, such as electrochemical processes. As known in the art, an “electrocatalyst” is a catalyst that can function to increase a rate of oxidation in an electrochemical reaction, e.g., carried out in an electrochemical cell. The electrocatalyst may be soluble in the cell medium or may be provided at an electrode surface or may be the electrode material/surface itself. In processes of the invention utilizing an electrocatalyst as defined and selected herein, the peptoid is typically provided pre-formed as a metal complex, optionally in combination with a borate species. In some cases, however, the electrocatalyst may not be pre-formed or provided as a metal peptoid complex, but rather be formed in situ.

The borate species may be any type of boron oxyanion of the form B(OH)ₓ⁻ⁿ, (such as orthoborate, metaborate, tetraborate and salts of any cation, wherein x may be 1, 2, 3 or higher and n may be 1, 2, 3, 4, 5, 6) which may be formed in solution, in-situ, at a pH ranging from 6-10.

In some embodiments, the borate species is one or a combination or a product formed of H₃BO₃ and NaOH, or by using sodium tetraborate and HCl.

In some embodiments, the borate species may be formed from Na₂B₄O₇·10H₂O and H₃BO₃.

In some embodiments, the borate species is Na₂B₄O₇·10H₂O.

In some embodiments, the borate species is a borate buffer, as known and used in the art (and which may be commercially available from various sources). In some embodiments, the borate buffer comprises sodium borate and NaCl.

Electrocatalysts of the invention, alone or in combination with a borate species, may be used in water oxidation processes for generating hydrogen fuel as a source of energy. Thus, in another of its aspects, there is provided an electrocatalyst of the invention for use in a method of water oxidation.

In some embodiments, the electrocatalyst is used in combination with a borate species.

The invention further provides an oxidation process, e.g., water oxidation, the process comprising treating a substrate material to be oxidized, e.g., water, with an electrocatalyst according to the present invention, under conditions causing oxidation of the substrate material.

In some embodiments, the substrate material is water and the process is for generating hydrogen gas.

The invention further provided a process for water oxidation, the process comprising treating water containing a borate species, as defined, with an electrocatalyst according to the present invention, under conditions enabling water oxidation and generation of hydrogen gas.

In some embodiments, the process is carried out in an electrochemical cell comprising a cathode compartment including a cathode electrode; an anode compartment including an anode electrode comprising the electrocatalyst for oxidation reactions; wherein water solutions are supplied to the anode compartment to be electrochemically oxidized on the electrocatalysts. In some configurations, the cell is non-partitioned and each of the compartments designates a region of the electrochemical cell.

The invention further provides a process for generating hydrogen fuel, the process comprising treating water with an electrocatalyst of the invention, in presence of a borate buffer, under conditions permitting oxidation of the water and generation of hydrogen gas.

In some embodiments, the electrocatalyst is a metal complex formed of a metal atom/ion and a peptoid selected amongst herein designated P1 through P26. In some embodiments, the peptoid is BEE, and the metal-peptoid complex is Cu₂(BEE)₂.

In some embodiments, the conditions permitting or causing oxidation, e.g., oxidation of water, comprise one or more of the following:
low applied potential of about +1.35 V vs. NHE;
presence of a borate species as co-catalyst;
pH greater than 7, and others.

In some embodiments, methods of the invention are carried out at room temperature (25 to 30° C.).

Further provided is a solid catalytic medium or matrix or material comprising an electrocatalyst according to the invention.

The invention further provides an electrode material comprising an electrocatalyst of the invention.

Further provided is an electrode comprising or consisting an electrocatalyst of the invention.

The invention further provides a device for electrolysis of water, the device comprises an electrode of the invention.

In some embodiments, the device is configured as an electrochemical cell.

In some embodiments, the electrolysis device is configured and operable for producing produce hydrogen, e.g., for household usage or as fuel for a variety of uses.

In some embodiments, the electrochemical cell comprises a cathode compartment including a cathode electrode; an anode compartment including an anode electrode comprising an electrocatalyst for oxidation reactions; wherein water solutions are supplied to the anode compartment to be electrochemically oxidized on the electrocatalysts.

The invention further provides an electrochemical bath comprising water, a borate buffer and at least one metal peptoid complex, wherein the metal peptoid complex is provided as an electrode material.

In some embodiments, the electrode material is or comprises the metal peptoid complex. In some embodiments, the electrode material is or comprises a BEE metal complex.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 depicts a structural difference between a peptide and a peptoid.

FIG. 2 depicts exemplary metal binding groups. The wiggly lines indicate connectivity to the peptoid structure.

FIG. 3 depicts exemplary proton acceptor groups. The wiggly lines indicate connectivity to the peptoid structure.

FIG. 4 depicts the submonomer method of synthesis used for preparing peptoids according to some embodiments of the invention.

FIG. 5 depicts substitution by ethylamine via its protected amine derivative N-Boc-ethylenediamine.

FIG. 6 depicts incorporation of ethanol and propanediol via their silyl-protected amine derivatives.

FIGS. 7A-C depict exemplary peptoids and complexes thereof according to the invention.

FIGS. 8A-C shows sequence of the peptoid BEE, the molecular structure of [Cu₂(BEE)₂(H₂O)](ClO₄)₄ and the ORTEP view (thermal ellipsoids set at 50% probability) of the cation [Cu₂(BEE)₂(H₂O)]⁴⁺ crystalized from water. The counter anions and selected hydrogen atoms are omitted for clarity.

FIGS. 9A-B show (A) UV-Vis spectra of 0.1 mM Cu₂(BEE)₂ in water and in borate buffer solution; insert: 0.3 mM of Cu₂(BEE)₂ in water and in borate buffer solution and (B) CV of 0.2 M borate buffer solution at pH 9.35 in the presence or absence of 1 mM Cu₂(BEE)₂. Scan rate=100 mV/s, glassy carbon electrode as the working electrode. Inset: CV of the Cu^{II}Cu^{I}/Cu₂^{I} and Cu₂^{II}/Cu^{II}Cu^{I} couple at the range between −0.5 to 0.6 V vs. NHE.

FIGS. 10A-B show the total accumulated charge (A) and O₂ evolution (B) during CPE in 0.2 M borate buffer (pH 9.35), in the absence or presence of 0.5 mM Cu₂(BEE)₂ using glassy carbon as working electrode at applied potential of +1.35 V. Evolved O₂ was measured by a fluorescence probe placed in the headspace of the electrochemical cell during the CPE.

FIGS. 11A-B show the accumulated charge (A) and evolved O₂ (B) during each 30 min CPE cycle. Experiments done at 1.35 V with 0.5 mM Cu₂(BEE)₂ at pH=9.35 in 0.2 M borate buffer solution. Every 30 min the CPE was stopped, and the pH was readjusted to 9.35.

FIGS. 12A-D show the CVs of 0.5 mM Cu₂(BEE)₂ at different scan rates with (A) a broad scanning range (0.4 to 1.9 V) or (B) a narrow scanning range (−0.3 to 0.6 V); inset shows the linear regression of i_{d} versus v^{1/2}. (C) Linear regression of i_{cat}/i_{d} versus v^{-1/2}. (D) k_{obs} values at various scan rates and the red line represents the value of average k_{obs}, they were done by FOWA. All experiments were performed in 0.2 M borate buffer at pH 9.35.

FIGS. 13A-B show (A) Pourbaix diagram of Cu₂(BEE)₂ in 0.2 M borate buffer in range of pH 8˜11; (B) CVs of Cu₂(BEE)₂ in 0.2 M borate buffer dissolved in H₂O or D₂O; insert is the enlarged scale of range between −0.8 V to +0.6 V.

FIG. 14 depicts a proposed mechanism cycle of Cu₂(BEE)₂ for water oxidation in borate buffer solution.

FIGS. 15A-D show (A) Molecular and (B) crystal structure of Cu₂BE₂; (C) CVs of 1 mM of Cu₂BEE₂ and Cu₂BE₂ in 0.2 M borate buffer at pH 9.35; (D) accumulated charge and (insert) oxygen during 30-minute CPE experiment with η 750 mV in 0.2 M borate buffer at pH 9.35.

FIG. 16 shows a plot of TOF-η relationship of Cu₂BEE₂ and Cu₂BE₂ in 0.2M borate buffer at pH 9.35; data extracted from FOWA analysis.

FIGS. 17A-B compares use of different borate buffers. (A) is the CV comparison in 0.4 M borate buffer at pH 7. The E1/2 of Cu₂(BDiE)₂ is +1.55 V and the E1/2 of Cu₂(BEE)₂ is +1.44 V. However, the current intensity of Cu₂(BDiE)₂ is much higher than that of Cu₂(BEE)₂, which is 75 vs. 14 μA. In the same condition, the turnover frequency values were also calculated by foot-of-the-wave analysis (FOWA), showing that Cu₂(BDiE)₂ is over 100-fold faster than Cu₂(BEE)₂ for water oxidation, 470 vs. 4 s-1, respectively. (B) is the CV comparison in 0.2 M borate buffer at pH 9.35. The overpotential of both catalysts are quite similar.

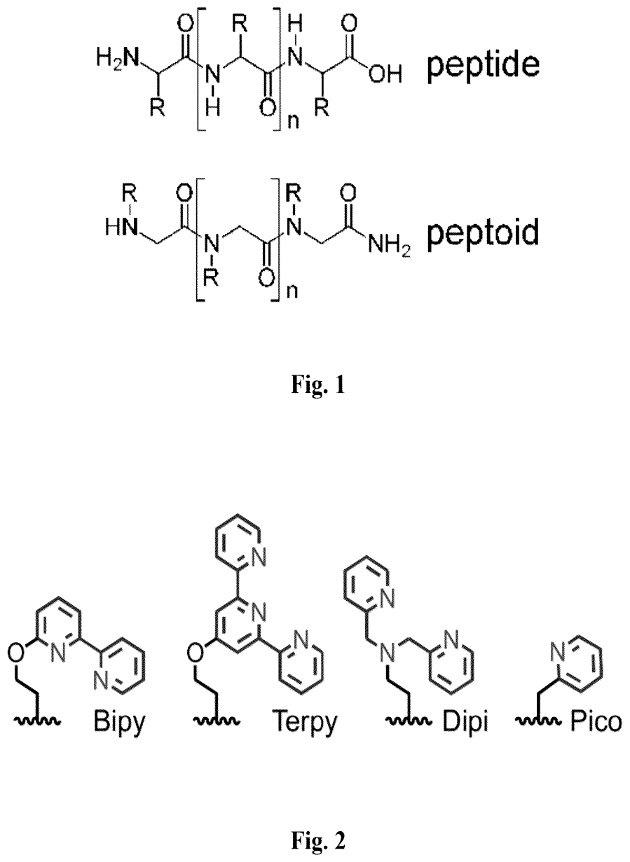

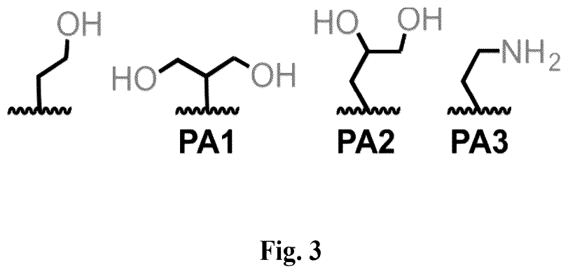

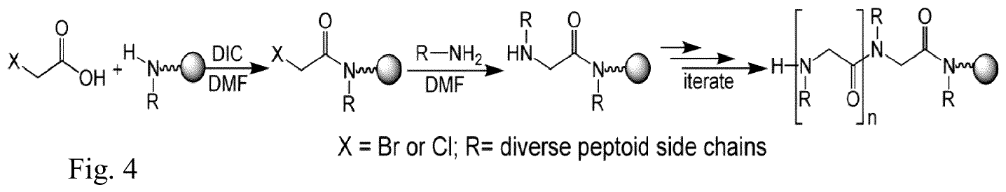

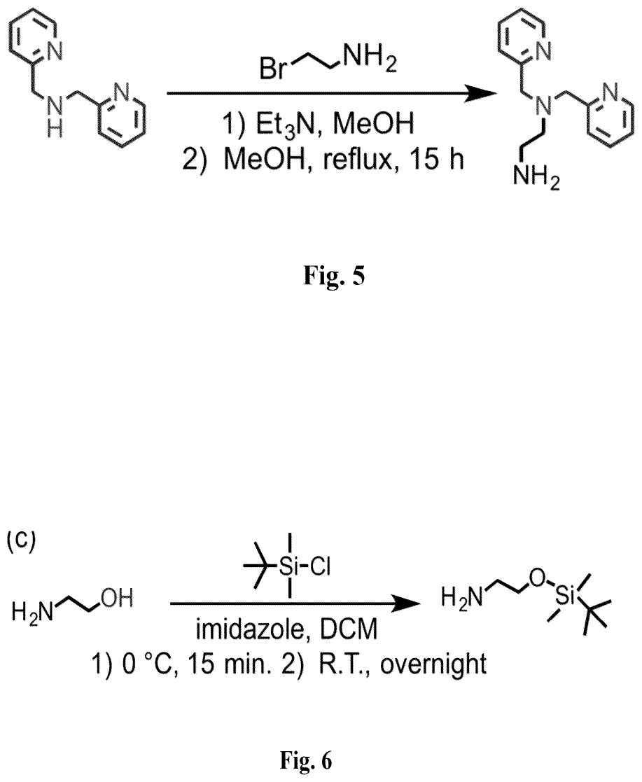

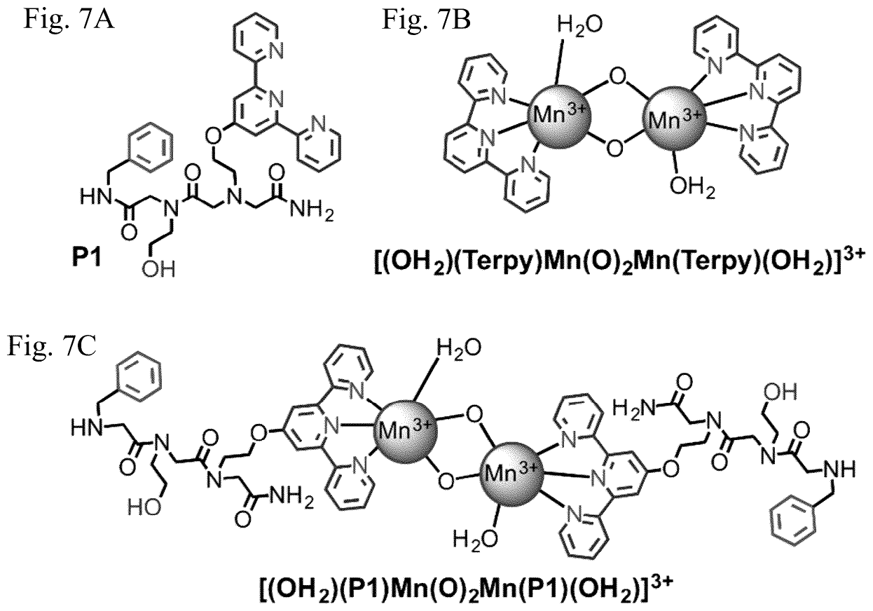

### DETAILED DESCRIPTION OF EMBODIMENTS

### Result and Discussion

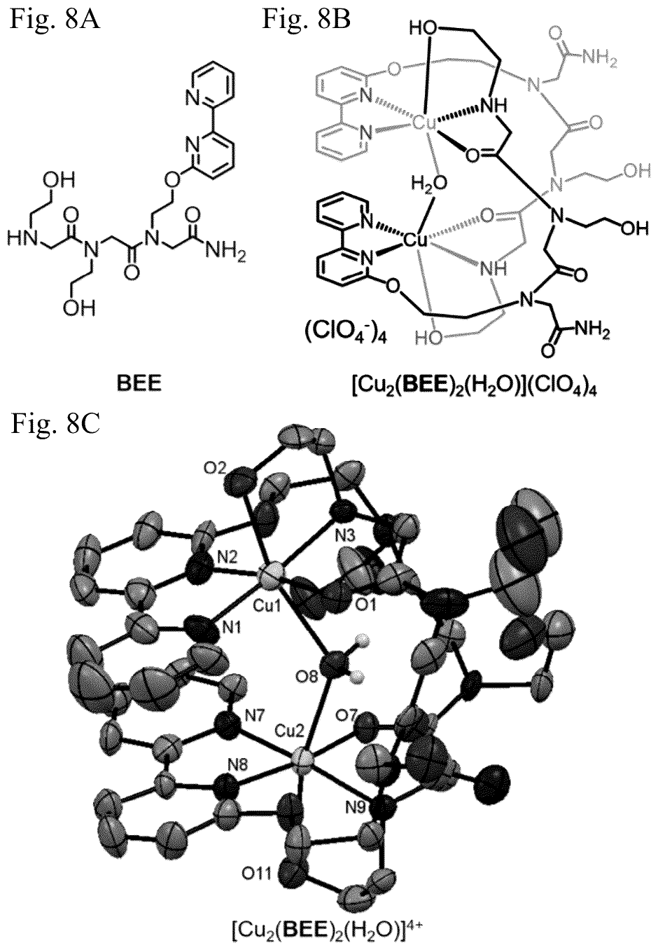

Synthesis and Characterization of BEE and its corresponding Cu(II) complex. The peptoid BEE was synthesized using a solid-phase method, cleaved from the solid support and purified by high-performance liquid chromatography (HPLC, >95% purity). The molecular weight measured by electrospray mass spectrometry (ESI-MS) was consistent with the mass expected for its sequence. This peptoid was treated with one equiv. of Cu(ClO₄)₂·6H₂O in methanol, and after 4 hours of stirring, greenish-blue precipitate was obtained. The precipitate was isolated and recrystallized from water. The structure consists of one [Cu₂(BEE)₂(H₂O)]⁴⁺ cation (having two Cu^{II} ions) and four perchlorate (ClO₄⁻) anions (Cu₂(BEE)₂. FIG. 8 shows the sequence of the peptoid BEE, the molecular structure of [Cu₂(BEE)₂(H₂O)](ClO₄)₄ and the ORTEP view (thermal ellipsoids set at 50% probability) of the cation [Cu₂(BEE)₂(H₂O)]⁴⁺ crystalized from water. The counter anions and selected hydrogen atoms are omitted for clarity.

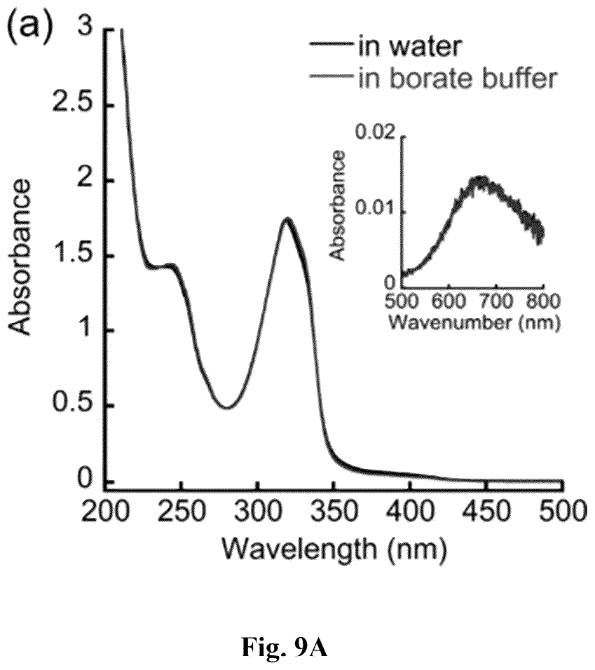

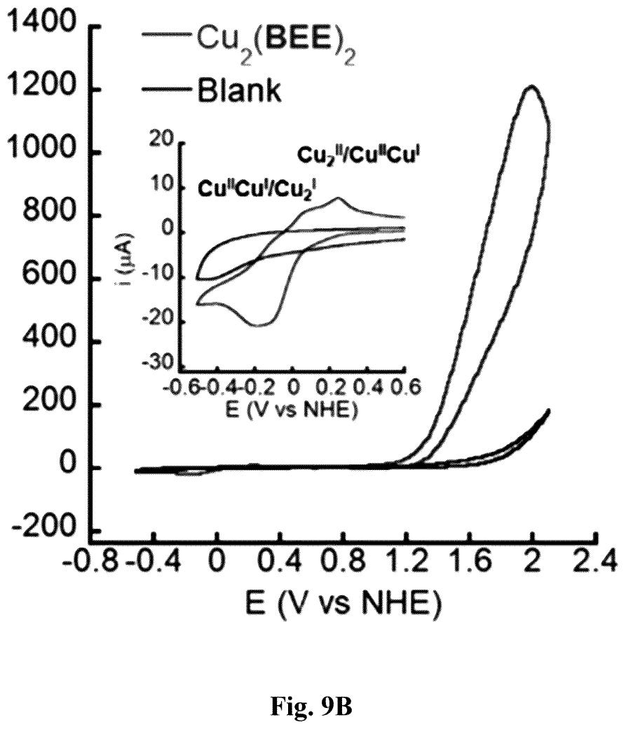

Electrochemical Studies. The electrochemical and electrocatalytic properties of Cu₂(BEE)₂ were evaluated in 0.2 M borate buffer at pH 9.35. The cyclic voltammetry (CV) was obtained in air using a glassy carbon (GC) working electrode and Ag/AgCl reference electrode. All the potentials are reported vs. the normal hydrogen electrode (NHE) by adding 0.197 V to the measured potential. As shown in FIG. 9B, two irreversible anodic waves at Eₚₐ=+0.05 V and +0.24 V were observed, and these correspond to the Cu^{II}Cu^{I}/Cu₂^{I} and Cu₂^{II}/Cu^{II}Cu^{I} redox couples. In addition, a high catalytic wave at Eₚₐ=+1.9 V was obtained, with an onset near +1.15 V, which corresponds to an onset overpotential of about 470 mV. To confirm that the catalytic wave represents water oxidation, the scan was revered and scanning was continued to a second scan, which showed a new reduction peak at −0.3 V assigned to oxygen reduction. This observation indicates that the oxygen is generated during or after the catalytic process, thus the catalytic process is water oxidation. Notably, Cu(ClO₄)₂·6H₂O is not stable in basic conditions as it immediately forms a blue precipitate. It may be therefore concluded that the use of BEE enables to obtain high catalytic peak intensity, and leads to significant stabilization of the Cu center in borate buffer in basic conditions.

The distance between Cu1 and Cu2 is 4.492 Å and they are bridged by one H₂O molecule. The two Cu—OH bonds, Cu1-O2 and Cu2-O11 are 2.491(7) Å and 2.415(6) Å respectively, representing asymmetry. The Cu1-O—Cu2 angle is 132.9(3°). Each Cu is coordinated to three N atoms (two from bipyridine of one peptoid and one from the secondary amine of the other peptoid) and three O atoms (one from the H₂O bridge, one from the —OH group and one from a backbone carbonyl group).

FIG. 9 shows the (a) UV-Vis spectra of 0.1 mM Cu₂(BEE)₂ in water and in borate buffer solution; insert: 0.3 mM of Cu₂(BEE)₂ in water and in borate buffer solution and (b) CV of 0.2 M borate buffer solution at pH 9.35 in the presence or absence of 1 mM Cu₂(BEE)₂. Scan rate=100 mV/s, glassy carbon electrode as the working electrode. Inset: CV of the Cu^{II}Cu^{I}/Cu₂^{I} and Cu₂^{II}/Cu^{II}Cu^{I} couple at the range between −0.5 to 0.6 V vs. NHE.

Complex characterization in solution was done in water and in 0.2 M borate buffer at pH 9.35, which is slightly above the pKa of B(OH)₃, where B(OH)₃ could react with water to form B(OH)₄⁻. Thus, this is the minimum pH in which B(OH)₄⁻ is the dominant species and can potentially promote the water oxidation process. It was found that the UV-Vis spectra of Cu₂(BEE)₂ in water (from where the crystal was obtained) and in borate buffer are identical (FIG. 9A), where 245 nm is assigned to n-π* transition of the amide backbone and BPy, 320 nm to Cu-BPy species and 680 nm to the d-d* transition of Cu^{II}. Further studies in borate buffer showed that (i) the absorption is linearly dependent on the catalyst concentration, indicating that the complex exists as a single species in the dinuclear form in the buffer solution, and (ii) that the spectrum does not change after 24 hours, demonstrating that the complex is stable in the buffer conditions. Electron spin resonance spectra (EPR) were performed in borate buffer at three different pH conditions, namely pH 7.50, 9.35 and 11.70. The spectra taken from the solutions at pH<9.4 revealed a signal at half-field region (ΔM_{S}=±2) at pH 7.50 and 9.35, indicating a triplet state species. Interestingly, this signal disappeared at pH 11.7, and the spectrum showed well-resolved four hyperfine structure at ΔM_{S}=±1 typical for a mononuclear Cu complex, indicating that at high pH Cu₂(BEE)₂ decomposes to the mononuclear Cu′ species (n=1, 1=3/2). This comparison clearly demonstrates the existence of the dinuclear Cu₂(BEE)₂ at pH 9.35. The broad hyperfine structure at lower pH suggests the presence of an extended magnetic exchange between the two Cu²⁺ centers, probably via hydrogen bonding. Interestingly, the ESI-MS spectrum of the complex in water shows a peak at m/z=1371.1326 consistent with [Cu₂(BEE)₂]⁴⁺+3ClO₄⁻ (z=1) as well as a peak at 1491.1327, which is consistent with [Cu₂(BEE)₂(H₂O)] and has a much lower intensity. Therefore, it was suggested that the complex exists in solution in the dicopper form, and that the bridging H₂O is labile. The structure of Cu₂(BEE)₂ was further supported by FT-IR and Raman spectroscopies. The FT-IR transmittance of the peptoid BEE at 1653 cm⁻¹ represents the (C═O of) amide bond stretching, and broad peaks at 3200 and 3390 cm⁻¹ are assigned to the combination of N—H and O—H stretching. Following CO coordination, a new peak arose at 1682 cm⁻¹, assigned to the stretching of (C═O(—Cu)). In addition, transmittance signals at 3267 and 3408 cm⁻¹ represent the stretching of (Cu—)N—H and (Cu—)O—H, respectively. Upon dissolving the complex in borate buffer, a similar spectrum to the one acquired in water, showing signals at the same wavenumbers, was obtained. To characterize the Cu—O and Cu—N bonds at low wavenumber region we measured the Raman spectrum of the complex, and this showed no shifts neither in water nor borate buffer at the range of 200 to 1500 cm⁻¹, demonstrating that the Cu—O and Cu—N stretching remain the same in both conditions. Overall, these results indicate that Cu₂(BEE)₂, which is most likely in equilibrium with Cu₂ (BEE)₂ (H₂O), exists both in water and in 0.2 M borate buffer at pH 9.35 and is stable in these conditions.

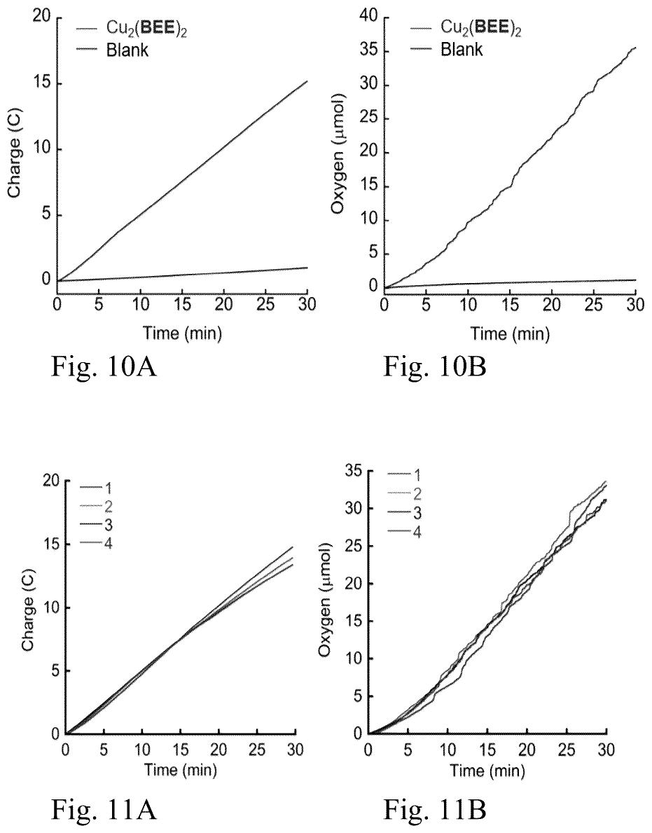

Water Oxidation Experiments. Evolution of molecular oxygen was investigated by controlled potential electrolysis (CPE) experiment at +1.35 V with a porous glassy carbon as working electrode in a 0.2 M borate buffer solution at pH=9.35 (FIG. 10).

FIG. 10 shows is the total accumulated charge (a) and O₂ evolution (b) during CPE in 0.2 M borate buffer (pH 9.35), in the absence or presence of 0.5 mM Cu₂(BEE)₂ using glassy carbon as working electrode at applied potential of +1.35 V. Evolved O₂ was measured by a fluorescence probe placed in the headspace of the electrochemical cell during the CPE.

Within 30 minutes, the evolved oxygen concentration was increased by 35.5 μmol with 0.5 mM Cu₂(BEE)₂ and by 1.5 μmol without it. This electrolysis experiment afforded a charge accumulation of about 15.2 C in the presence of Cu₂(BEE)₂, and of only 1.4 C in the absence of Cu₂(BEE)₂. Based on a 4e⁻ process, the 34 μmol of evolved oxygen and the total charge of 13.8 C accumulated in this process, and the initial amount of catalyst in solution, the Faradaic efficiency (FE %) and the catalytic turnover number (TON) were calculated to be 95% and 13.6 respectively in only 30 min. The current measured during the CPE increased dramatically in the first 4 min of the reaction up to a value of about 3.2 mA/cm², and was maintained steady in the next 26 min. This suggests that at the beginning of the reaction, the active species is formed via drastic conformational changes. This active catalyst can be either an insoluble species formed on the surface of the working electrode or an in-situ soluble molecular species formed in the solution. To probe this point, we repeated the first 500 seconds of the CPE using ITO working electrode 5 times in the same solution. After each experiment, the potential was turned off and the electrode was left in the solution for 5 min. The current increase during the first reaction was identical to the one observed in the 30 min CPE experiment, and each repetition showed a recovery from high to low current density, followed by a drastic increase during the electrolysis. Importantly, the current response of the electrode, after the CPE experiment, which was rinsed but not polished, in buffer solution that did not contain the catalyst, was identical to the current response obtained from a clean electrode in the same buffer solution, supporting the homogeneity of the CPE process. These results eliminate the attribution of an insoluble (adsorbed) species toward the increased current. Knowing that borate buffer can coordinate to Cu during the catalysis, it may be suggested that Cu₂(BEE)₂ is the pre-catalyst that forms the active catalyst while reacting with borate species from the buffer solution upon applying a potential. To confirm the participation of the buffer in the catalytic process, we first compared the CV scans of Cu₂(BEE)₂ in phosphate buffer and in borate buffer in the same conditions (0.2 M ion strength and pH 9.35). It was found that the onset potential of the catalytic event is about 250 mV lower in borate buffer than in phosphate buffer solution, suggesting that borate is a non-innocent buffer that can enhance the catalytic activity. Indeed, when quantitative amounts of borate species were added into a phosphate buffer solution containing the catalyst Cu₂(BEE)₂ the onset and the catalytic events shifted to lower potential, and the intensity of the catalytic peak increased with an increasing amount of added borate species. To further support the participation of the borate buffer in the electrocatalytic process, a series of CV scans in different buffer concentration was conducted. The results showed that while no catalytic activity was observed in un-buffered water solution (0 mM buffer concentration, i_{(H2O)}), the catalytic peak current (i_{(cat)}) was gradually increasing as the buffer concentration increased from 30 to 250 mM. The (i_{(cat)}/i_{(H2O)})² is proportional to the buffer concentrations, signifying the participation of the buffer ions in the catalytic event. These results also imply that the structural change of Cu₂(BEE)₂ does not stem from a catalyst decomposition but might be attributed to the coordination of borate species to Cu₂(BEE)₂. On the other hand, when the buffer concentration increases from 250 to 350 mM, the intensity of the catalytic wave plummets, and almost does not change once the buffer concentration is increasing. This might indicate that at high buffer concentrations polyborate ions are being formed, rather than the active catalyst, leading to an inhibition of the catalytic process.

The onset overpotential was determined by a series of CPE experiments with different applied potentials (+1.25, +1.20, +1.15, +1.10 V vs. NHE). Within 900 seconds (15 minutes), CPE at +1.10 V did not result in oxygen generation until the applied potential was increased to +1.15 V. Thus, we can conclude that +1.15 V is the minimal applied potential for the catalysis process with Cu₂(BEE)₂, which corresponds to an onset overpotential of 470 mV. This value is considerably low compared to other reported Cu-based complexes at mild pH conditions.

Catalyst Stability and Re-Use. Importantly, under these reaction conditions, no precipitation was observed, and the catalyst remained intact as evident from the UV-Vis spectrum and CV taken before and after 30 min of electrolysis. A pH decrease to 9.05 was measured, and is consistent with proton formation during electrolysis. As the catalyst remained intact after CPE experiment, we envisioned that the catalytic solution could be recycled by adjusting its pH back to 9.35 after 30 min of reaction towards a significant increase in the overall TON. To explore this possibility, 0.5 mM Cu₂(BEE)₂ solution was subjected to a CPE experiment with an applied potential of +1.35 V, in which the reaction was stopped every 30 min. and the pH was adjusted to 9.35 (FIG. 11). Keeping the amount of Cu₂(BEE)₂ constant in the solution, we have obtained a TON as high as 51.8 in only 2 hours (4 repeating cycles).

FIG. 11 shows the accumulated charge (a) and evolved O₂ (b) during each 30 min CPE cycle. Experiments done at 1.35 V with 0.5 mM Cu₂(BEE)₂ at pH=9.35 in 0.2 M borate buffer solution. Every 30 min the CPE was stopped, and the pH was readjusted to 9.35.

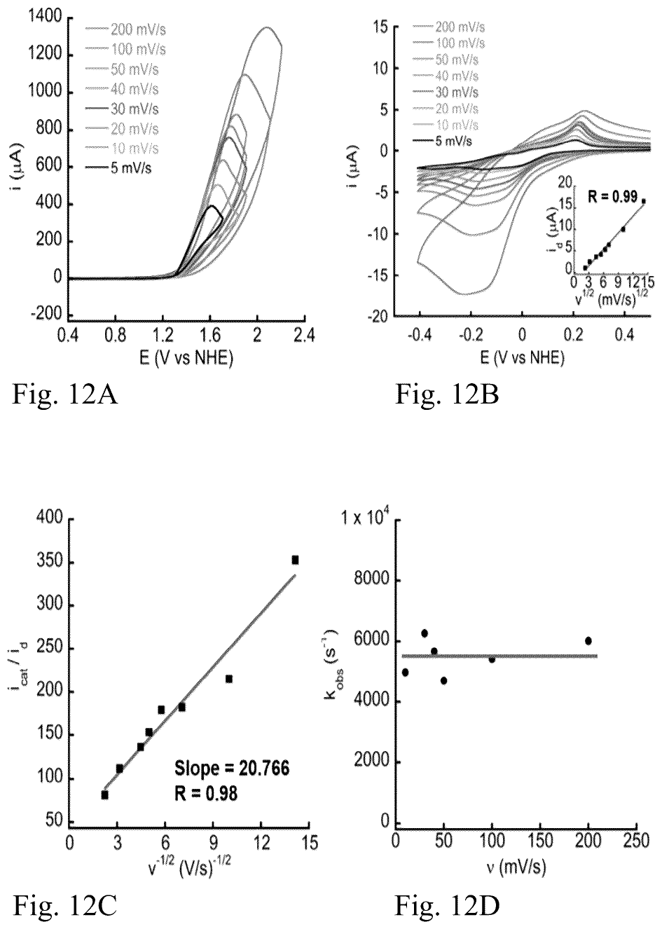

Homogeneity Studies. At this point we wished to explore whether the catalyst Cu₂(BEE)₂ is operating solely in solution or if an active catalyst is being formed and deposited on the electrode surface leading to a heterogeneous process. To this aim, we removed the glassy carbon electrode from a solution of Cu₂(BEE)₂ (0.5 mM in 0.2 M borate buffer, pH 9.35) after carrying out 25 continuous CV scans from 0.4 to 2.1 V, rinsed it with water (the electrode was not polished), and placed it in fresh 0.2 M borate buffer solution at pH 9.35 without Cu₂(BEE)₂. The CV scan of this solution showed only the buffer response. Scanning electron microscope (SEM) images of the working electrode surface before and after 25 continuous CV scans, showed no particle deposited on the electrode surface. In addition, another 30-min CPE experiment was conducted with ITO as the working electrode, which was analyzed by HR-SEM and EDS before and after the reaction. No particles on the electrode's surface were found in HR-SEM, and no Cu element was found attached during EDS spectrum after electrolysis. Moreover, the CV scans at different scan rates (FIG. 12) show that the peak current (i_{d}, corresponding to the reduction peak current of Cu₂^{II}/Cu^{II}Cu^{I}) varies linearly with the root of scan rate, v^{1/2}. Considering the irreversibility, i_{d} and v^{1/2} follow the relation as below:

$$\\ \begin{matrix}{i}_{d} = 0.446 {( {n}_{d} F )}^{3 / 2} A [ Cu ] {( \frac{α {D}_{Cu} v}{RT} )}^{1 / 2} & ( eq . 1 )\end{matrix}$$

The value of the diffusion coefficient D_{Cu} was calculated to be 1.28×10⁻⁵ cm²/s, which is consistent with the diffusion-controlled process (10⁻⁶˜10⁻⁵ cm²/s). Collectively, these results indicate that the catalytic process is truly homogeneous.

FIG. 12 shows the CVs of 0.5 mM Cu₂(BEE)₂ at different scan rates with (a) a broad scanning range (0.4 to 1.9 V) or (b) a narrow scanning range (−0.3 to 0.6 V); inset shows the linear regression of i_{d} versus v^{1/2}. (c) Linear regression of i_{cat}/i_{d} versus v^{-1/2}. (d) k_{obs} values at various scan rates and the red line represents the value of average k_{obs}, they were done by FOWA. All experiments were performed in 0.2 M borate buffer at pH 9.35.

Kinetic Studies. CV scans of solutions containing different concentrations of the catalyst were performed to gain some insight regarding its kinetics. The linear dependence of the catalytic peak current on the catalyst's concentration, points out that the water oxidation is performed by a single molecular catalysis reaction with first-order kinetics. Therefore the catalytic process obeys the relationship displayed in eq. 2:

i_{cat}=n_{cat}FA[Cu](k_{cat}D_{cu})^{1/2} (eq. 2)

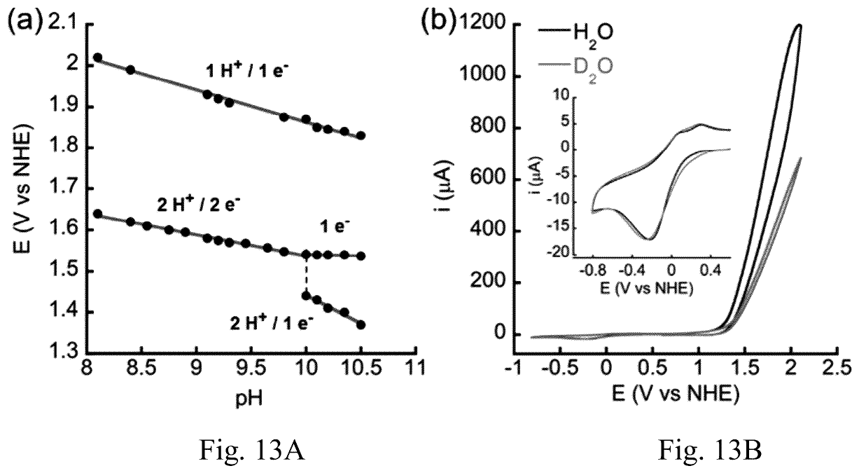

The correlation between i_{cat}/i_{d} and v^{-1/2} could then be obtained and the value of the rate constant could be calculated by the linear slope of i_{cat}/i_{d} and v^{-1/2} (FIG. 13) as shown in eq. 3:

$$\\ \begin{matrix}\frac{{i}_{cat}}{{i}_{d}} = 1.827 {k}_{cat}^{1 / 2} {v}^{- 1 / 2} & ( eq . 3 )\end{matrix}$$

From these equations, the slope value (FIG. 13A) was calculated to be 20.766 with the correlation coefficient (R) being 0.98, and k_{cat} was calculated to be 129 s⁻¹. To further conform the fast kinetics by Cu₂(BEE)₂, FOWA was performed at various scan rates and the average k_{obs} was determined as 5503 s⁻¹ (FIG. 13B). To the best of our knowledge, the TOF value calculated by either method is the highest reported for copper-based homogeneous electrocatalysts, calculated by one (or both) of these methods.

FIG. 13 shows (a) Pourbaix diagram of Cu₂(BEE)₂ in 0.2 M borate buffer in range of pH 8˜11; (b) CVs of Cu₂(BEE)₂ in 0.2 M borate buffer dissolved in H₂O or D₂O; insert is the enlarged scale of range between −0.8 V to +0.6 V.

Mechanism. It may be suggested that Cu₂(BEE)₂ exists in solution in equilibrium with Cu₂(BEE)₂(H₂O). Based on the behavior of the current during our CPE experiments, the current intensity dependence on the buffer concentration and the relevant literature, it is proposed that in the first step of the reaction, the borate buffer coordinates to the Cu center upon applying a potential. To further support the structural change associate with borate coordination to Cu₂(BEE)₂(H₂O), and to explore what is the potential required for borate coordination to take place, a series of spectroelectrochemistry experiments at different applied potentials were performed. At applied potential +1.10 V, which is lower than the onset potential in borate buffer (+1.15 V), the UV-Vis spectrum does not change after 400 s of electrolysis, indicating that no structural change has occurred. In contrast, once the applied potential is higher than the onset potential (e.g. +1.35 V and +1.55 V), substantial changes in the UV-Vis absorbance were observed during electrolysis: the absorbance band at 245 nm increased, a new shoulder band appeared near 309 nm (associated with the Cu—B(OH)₄⁻ complex) and the band near 320 nm (associated with Cu-BPy) decreased. In addition, an isosbestic point was observed near 312 nm, implying the structural change is taking place within the Cu-BPy species, and suggesting that the borate species coordinate to Cu to form a new Cu-BPy-borate complex represented by the shoulder band near 309 nm. As control, the same experiment was conducted in phosphate buffer at an applied potential of +1.6 V and this resulted in no change in this region (about 309 nm). The results from the spectroelectrochemistry experiments support our proposal that borate species coordinates to the Cu center of the catalyst and indicates that the borate coordination happens only when the applied potential is higher than the onset potential. These results signify that borate coordination to Cu occurs together with the electron(s) and proton(s) transfer(s) that initiate water oxidation.

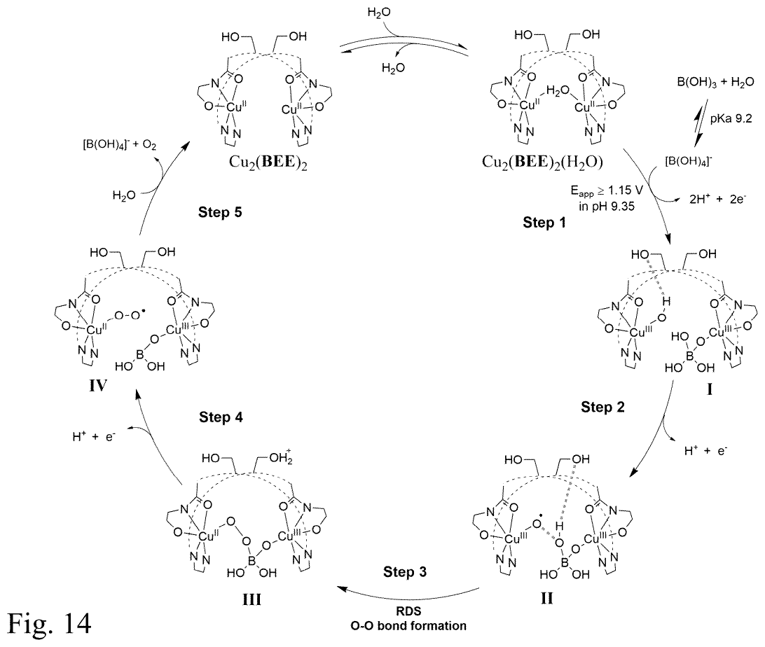

To quantify the electron(s) and proton(s) transfer(s) that occur in the first step of the reaction and propose the structure of this borate-bound complex, DPV scans in different pH conditions were performed and plotted vs. the catalytic potentials to form a Pourbaix diagram (FIG. 14). The catalytic wave obtained from the DPV scans consists of two oxidation waves when pH<10 and three waves when pH≥10. The slope value of the first wave <pH 10 is 0.053, which is close to 0.059, the nH⁺/ne⁻ transfer process. However, in pH≥10, the oxidation event splits into two events: a slope of 0.136 representing 2H⁺/1e⁻ process and a slope of 0, indicating only 1e⁻ transfer process. Thus, the overall oxidation event at pH<10 can be rationally concluded as 2H⁺/2e⁻ process because the value of its slope is 0.053 which is similar to 0.059 determined by the Nernst equation. Combining these results and the asymmetrical bond length between the H₂O molecule and the Cu centers in Cu₂(BEE)₂(H₂O), we propose that the first step of the catalytic reaction proceeds via two consecutive PCET processes. In the first process, the shorter Cu^{II}—H₂O is oxidized to Cu^{III}—OH and the longer Cu^{II}—H₂O bond cleaves, enabling the coordination of the non-innocent buffer species, which occurs during the second PCET process.

FIG. 14 depicts a proposed mechanism cycle of Cu₂(BEE)₂ for water oxidation in borate buffer solution.

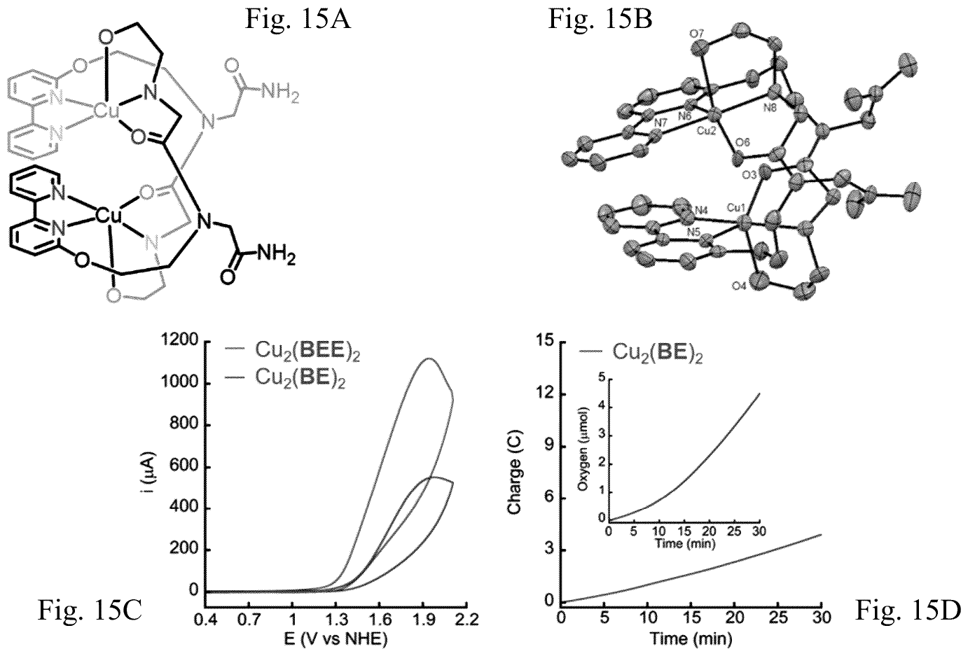

First, in the crystal structure of Cu₂(BEE)₂(H₂O), the distance between the oxygen atom of the —OH group in the unbound ethanolic side chains and the proton atom of the bridging H₂O molecule is 3.247 Å, suggesting weak electrostatic interaction between these atoms and a possible H-bonding that should stabilize the formed Cu^{III}—OH center. Second, due to the equilibrium of boric acid, B(OH)₃+H₂O═B(OH)₄⁻+H⁺ (pKa=9.2), it is reasonable that in our reaction conditions, i.e. pH 9.35, the coordinating borate species is B(OH)₄⁻ anion. Thus, in the second PCET process B(OH)₄⁻ coordinates to Cu forming a Cu^{III}—OB(OH)₃ while a proton is being abstracted into the solution. This is in accordance with our observation that borate coordination to Cu center only occurs when the applied potential is above the onset potential, i.e., the potential that initiates catalysis. Third, in this oxidation event, the linear slope (0.016) obtained from the plot of E vs. ln[B(OH)₄⁻] matches the stoichiometry ratio of 1:1 Cu₂(BEE)₂(H₂O):[B(OH)₄⁻]. Together, both PCET processes shown below lead to the formation of I (step 1, FIG. 15):

[CO^{II}₂(BEE)₂(H₂O)]⁴⁺+[B(OH)₄]→{Cu^{III}₂(BEE)₂(OH)[B(O)(OH)₃]}³⁺+2H⁺+2e⁻ (Step 1)

According to the Pourbaix diagram, the second oxidation event is also 1H⁺/1e⁻ transfer process as its slope value is 0.075 (close to 0.059). The H-bond between the Cu^{III}—OH center and the —OH group of the ethanolic side chain might accelerate the proton transfer in this process, to form II (Step 2, FIG. 15), in which the Cu—O—B(OH)₃ center is stabilized by a H-bonding between the O atom from the —OH group of the unbound ethanolic side chain and one of the H atoms of —B(OH)₃:

{Cu^{III}₂(BEE)₂(OH)[B(O)(OH)₃]}³⁺→{Cu^{III}₂(BEE)₂(O·)(B(O)(OH)₃]}³⁺+H⁺+e⁻ (Step 2)

FIG. 15 shows (a) Molecular and (b) crystal structure of Cu₂BE₂; (c) CVs of 1 mM of Cu₂BEE₂ and Cu₂BE₂ in 0.2 M borate buffer at pH 9.35; (d) accumulated charge and (insert) oxygen during 30-minute CPE experiment with η 750 mV in 0.2 M borate buffer at pH 9.35.

Next, the kinetic isotope effect (ME) of complex Cu₂(BEE)₂ was evaluated based on the difference of the catalytic currents acquired in H₂O and D₂O (FIG. 6b). According to the equation: k_{H2O}/k_{D2O}=(i_{H2O}/i_{D2O})², the H₂O/D₂O KIE value was calculated to be 3.0. This value is consistent with a possible atom-proton transfer (APT) process in the O—O bond formation rate-determining step (RDS). Knowing that the —OH group can stabilize the metal center via H-bonding, we suggest that it acts as an intramolecular proton acceptor in the O—O bond formation via APT process. In addition, a previous study has provided evidence that B(OH)₄⁻ could be a co-catalyst in this reaction, acting as an oxygen donor that provides one of its —OH groups to attack the Cu^{III}—O· species, forming the O—O bond. Together, the APT and O—O bond formation processes lead to III (step 3, FIG. 15):

{Cu^{III}₂(BEE)₂(O·)[B(O)(OH)₃]}³⁺→{Cu^{III}Cu^{II}(BEE)(BEEH)[(OO)B(O)(OH)₂]}³⁺ (Step 3)

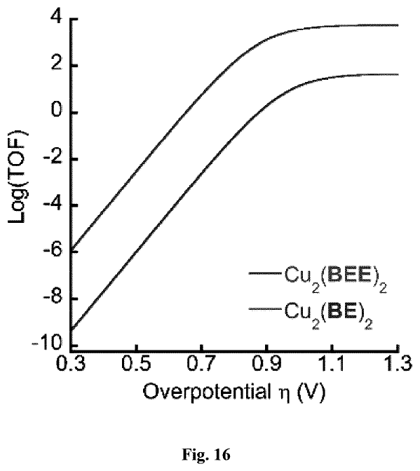

To support the role of the side chain —OH groups as proton acceptors, a control peptoid dimer BE, was prepared, which lacks one of the ethanolic side chains and generates the corresponding Cu complex via the same synthetic procedure used for the preparation of Cu₂(BEE)₂. The crystal structure obtained from a single crystal analysis of this complex suggests the formation of the dinuclear complex Cu₂(BE)₂ (FIG. 16A-B). Notably, in this crystal structure, there is no bridging H₂O molecule between the two copper centers, probably due to its shorter Cu—Cu distance (4.270 Å vs. 4.492 Å of Cu₂(BEE)₂); and the only —OH side chain of BE is bound to the Cu center, illustrating no dangling —OH groups in this complex. Following the solid-state characterization, the complex was characterized in solution both in 0.2 M borate buffer at pH 9.35 and in water, applying a variety of techniques including UV-Vis, FT-IR, EPR and Raman spectroscopies as well as ESI-MS.

FIG. 16 shows a plot of TOF-η relationship of Cu₂BEE₂ (red line) and Cu₂BE₂ (blue line) in 0.2M borate buffer at pH 9.35; data extracted from FOWA analysis.

The results obtained from all these measurements confirmed the existence of Cu₂(BE)₂ without the bridging-water molecule also in solution. Interestingly, the CV of Cu₂(BE)₂ exhibited a much lower catalytic wave than the one observed with Cu₂(BEE)₂ and the onset potential was higher compared to that of Cu₂(BEE)₂ in the same conditions (FIG. 16C). A kinetic study conducted with the peak current of Cu₂(BE)₂ used to evaluate the k_{cat} resulted in only 19 s⁻¹. Moreover, a CPE experiment (FIG. 16D) demonstrated that within 30 min, Cu₂(BE)₂ performed with Faradaic efficiency of 70% and TON of only 1.2, with an 11 higher than this of Cu₂(BEE)₂ (750 vs. 650 mV). Moreover, the TOF-η relationships were also analyzed using the method of Costentin and Saveant and the calculated TOF values by FOWA. As seen in FIG. 16, prior to reaching a maximum, the TOF of Cu₂(BEE)₂ is exponentially higher than that of Cu₂(BE)₂ at the same II Also, to reach the TOFₘₐₓ, Cu₂(BEE)₂ requires lower 11 than Cu₂(BE)₂ (0.90 V vs. 1.05 V). To further understand the role of the —OH group from the ethanolic side chain at the 2^{nd} position of the trimer BEE, in the catalytic activity, another trimer peptoid, BPE, having a non functional propyl side chain in the 2^{nd} position rather than this specific ethanolic group, was prepared as a control. The corresponding Cu complex, Cu₂(BPE)₂, was prepared and characterized as described above, and its crystal structure revealed a H₂O bridge between the two Cu centers as well as a Cu—Cu distance of 4.550 Å, similar to the crystal structure of Cu₂(BEE)₂. However, the CV of this complex in the same reaction conditions as before was similar to this of Cu₂(BE)₂, showing lower catalytic activity compared to this of Cu₂(BEE)₂. Collectively, the results obtained from the electrocatalytic and kinetic studies support our assumption that the dangling —OH groups within Cu₂(BEE)₂ play an important role in the water oxidation process (Table 1).

TABLE 1
Comparison between the electrochemical and catalytic
properties of Cu₂(BEE)₂ and Cu₂(BE)₂.

| | η^{a} | FE %^{b} | TON^{b} | k_{cat}^{c} | k_{obs}^{d} |
|---|---|---|---|---|---|
| Cu₂(BEE)₂ | 650 mV | 95% | 13.6 | 129 s⁻¹ | 5503 s⁻¹ |
| Cu₂(BE)₂ | 750 mV | 70% | 1.2 | 19 s⁻¹ | 51 s⁻¹ |

^{a}η: overpotential for CPE experiments;
^{b}data from 30-min electrolysis experiments;
^{c}calculated from eq. 3;
^{d}calculated from FOWA (see detail in ESI).

Following the RDS, we propose that the B—O bond cleaves with losing one electron coupled with the proton accepted by the dangling —OH groups to form the transition state IV (Step 4, FIG. 6):

{Cu^{III}Cu^{II}(BEE)(BEEH)[(OO)B(O)(OH)₂]}³⁺→Cu^{III}Cu^{II}(BEE)₂[(OO·)B(O)(OH)₂]}³⁺+H⁺+e⁻ (Step 4)

Due to the pKa of boric acid (pKa=9.2), a water molecule reacts with the coordinated B(O)(OH)₂ to form [B(OH)₄]⁻, therefore, it dissociates from Cu^{III}, where the (OO·) radical can coordinate and be stabilized. Finally, dioxygen is released to complete the catalytic cycle, as Cu₂(BEE)₂ complex is re-generated (Step 5, FIG. 15):

{Cu^{III}Cu^{II}(BEE)₂[(OO·)B(O)(OH)₂]}³⁺+H₂O→[Cu^{II}₂(BEE)₂(H₂O)]⁴⁺+[B(OH)₄]⁻+O₂ (Step 5)

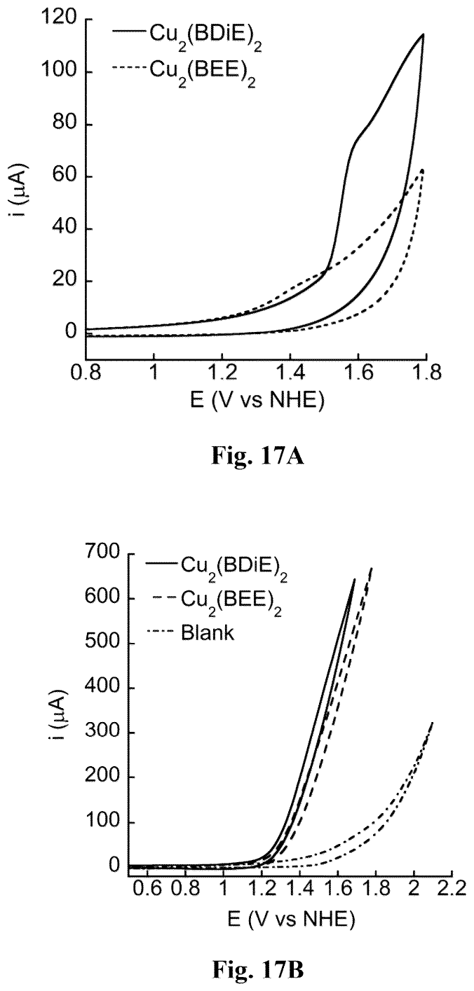

The nature of the borate buffer seems to have no weight on the process and products of the invention. As FIG. 17A demonstrates, the overpotential of the different borate buffers are quite similar. It is rational due to the additional dangling —OH groups in Cu₂(BDiE)₂ minorly assisting the proton transfer process in the rate-determining step as an extra proton acceptor.

1. An oxidative aqueous medium comprising a metal-peptoid complex comprising
at least one metal ion associated to a peptoid oligomer incorporating at least one metal-binding ligand and at least one proton acceptor group; and
a borate species.

2. The medium according to claim 1, wherein the metal-peptoid complex has an organic chain and at least one metal ion associated therewith, wherein the organic chain is of a structure A-B, wherein A is at least one metal-binding ligand and B is at least one proton acceptor group, wherein A and B are associated via an amide bond, or a linker spacer comprising one or more organic functionality.

3. The complex according to claim 1, wherein the metal-peptoid complex is a N-substituted glycine oligomer comprising between 2 and 15 glycine units.

4. The complex according to claim 1, wherein the at least one metal binding ligand is a N-containing heteroaryl, biaryl or fused heterocyclic.

5. The medium according to claim 1, wherein the at least one binding group is selected from Bipy, Terpy, Dipi and Pico, respectively being of formula 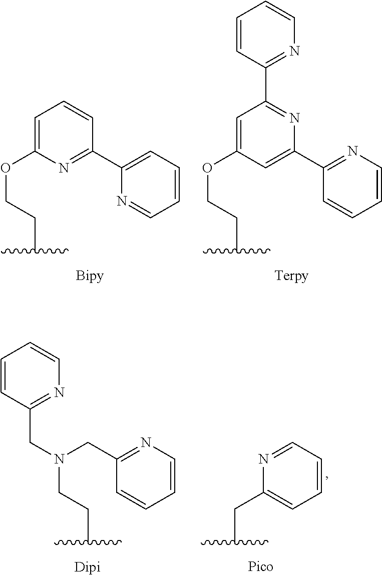
wherein the wiggly line designates a point of connectivity to N atom of a glycine unit.

6. The medium according to claim 1, wherein the at least one proton acceptor group comprises an atom selected from oxygen, nitrogen and sulfur.

7. The medium according to claim 6, wherein the at least one proton acceptor group is selected amongst groups containing hydroxyl functionalities and amine functionalities.

8. The medium according to claim 1, wherein the at least one proton acceptor group is selected from ethanol-yl, PA1, PA2 and PA3, respectively having structure,

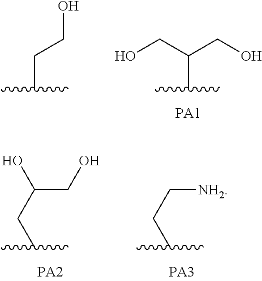

9. The medium according to claim 1, wherein the peptoid comprises at least one metal binding ligand and at least one proton acceptor group, wherein the at least one metal binding ligand is selected amongst pyridinyl, Bipy, Terpy, DiPi and Pico, and the at least one proton acceptor group is selected from ethanol-yl, PA1, PA2 and PA3.

10. The medium according to claim 1, wherein the peptoid comprises one or two metal binding ligands and one or two proton acceptor groups.

11. The medium according to claim 1, wherein the metal ion is selected from copper ions, cobalt ions, manganese ions, nickel ions, iron ions, ruthenium ions, rhodium ions, and iridium ions.

12. The medium according to claim 1, wherein the metal peptoid complex comprising a metal ion and a peptoid, selected from:

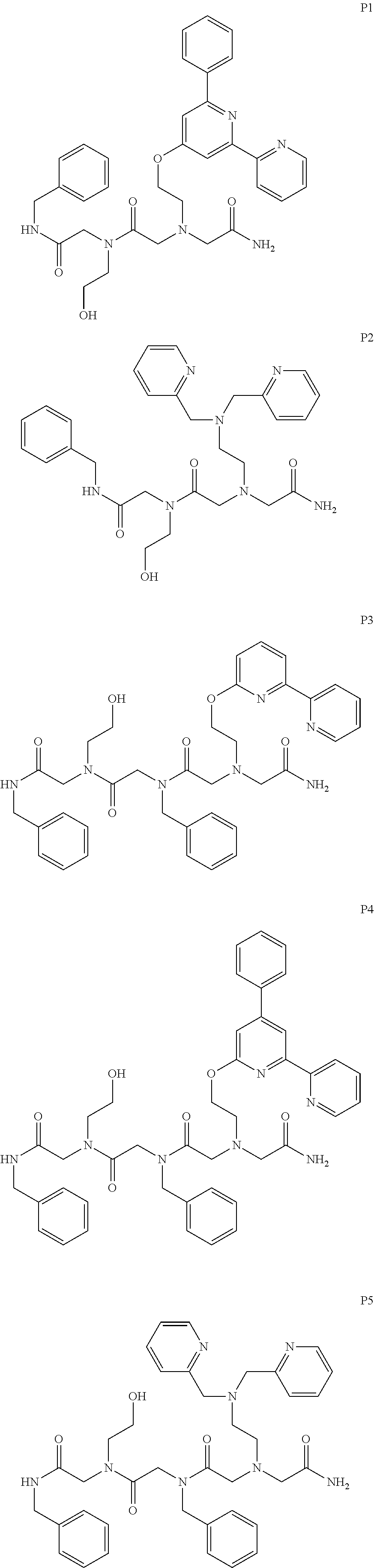 [SMILES: NC(=O)CN(CCOc1cc(-c2ccccc2)nc(-c2ccccn2)c1)CC(=O)N(CCO)CC(=O)NCc1ccccc1 ; NC(=O)CN(CCN(Cc1ccccn1)Cc1ccccn1)CC(=O)N(CCO)CC(=O)NCc1ccccc1 ; NC(=O)CN(CCOc1cccc(-c2ccccn2)n1)CC(=O)N(CC(=O)N(CCO)CC(=O)NCc1ccccc1)Cc1ccccc1 ; NC(=O)CN(CCOc1cc(-c2ccccc2)cc(-c2ccccn2)n1)CC(=O)N(CC(=O)N(CCO)CC(=O)NCc1ccccc1)Cc1ccccc1 ; NC(=O)CN(CCN(Cc1ccccn1)Cc1ccccn1)CC(=O)N(CC(=O)N(CCO)CC(=O)NCc1ccccc1)Cc1ccccc1]

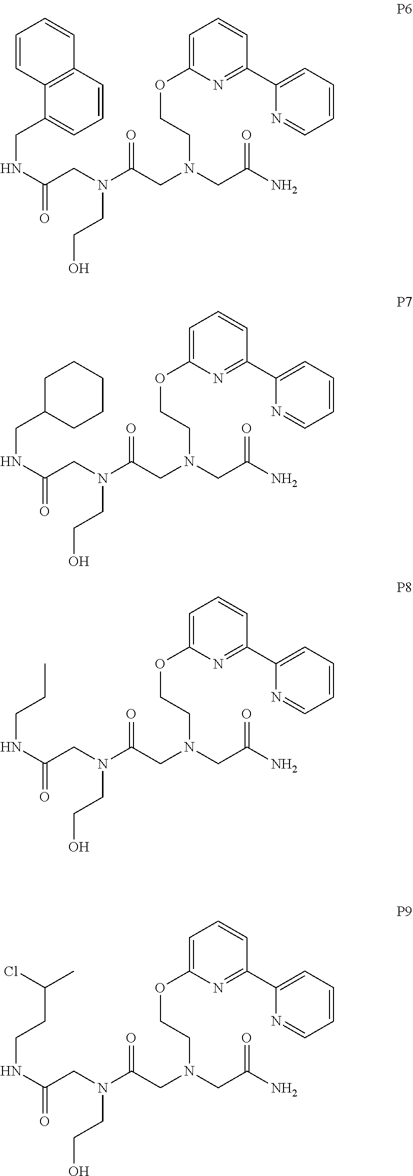 [SMILES: NC(=O)CN(CCOc1cccc(-c2ccccn2)n1)CC(=O)N(CCO)CC(=O)NCc1cccc2ccccc12 ; NC(=O)CN(CCOc1cccc(-c2ccccn2)n1)CC(=O)N(CCO)CC(=O)NCC1CCCCC1 ; CCCNC(=O)CN(CCO)C(=O)CN(CCOc1cccc(-c2ccccn2)n1)CC(N)=O ; CC(Cl)CCNC(=O)CN(CCO)C(=O)CN(CCOc1cccc(-c2ccccn2)n1)CC(N)=O]

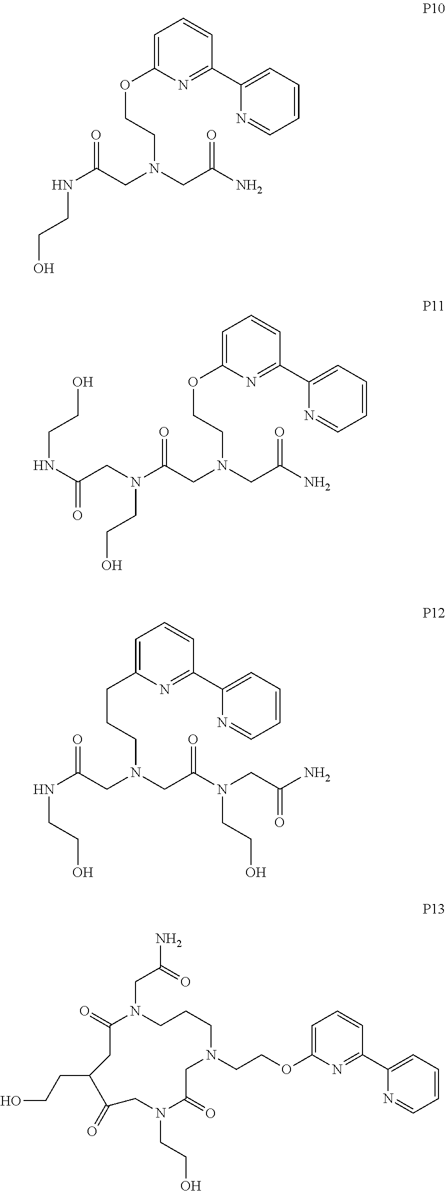 [SMILES: NC(=O)CN(CCOc1cccc(-c2ccccn2)n1)CC(=O)NCCO ; NC(=O)CN(CCOc1cccc(-c2ccccn2)n1)CC(=O)N(CCO)CC(=O)NCCO ; NC(=O)CN(CCO)C(=O)CN(CCCc1cccc(-c2ccccn2)n1)CC(=O)NCCO ; NC(=O)CN1CCCN(CCOc2cccc(-c3ccccn3)n2)CC(=O)N(CCO)CC(=O)C(CCO)CC1=O]

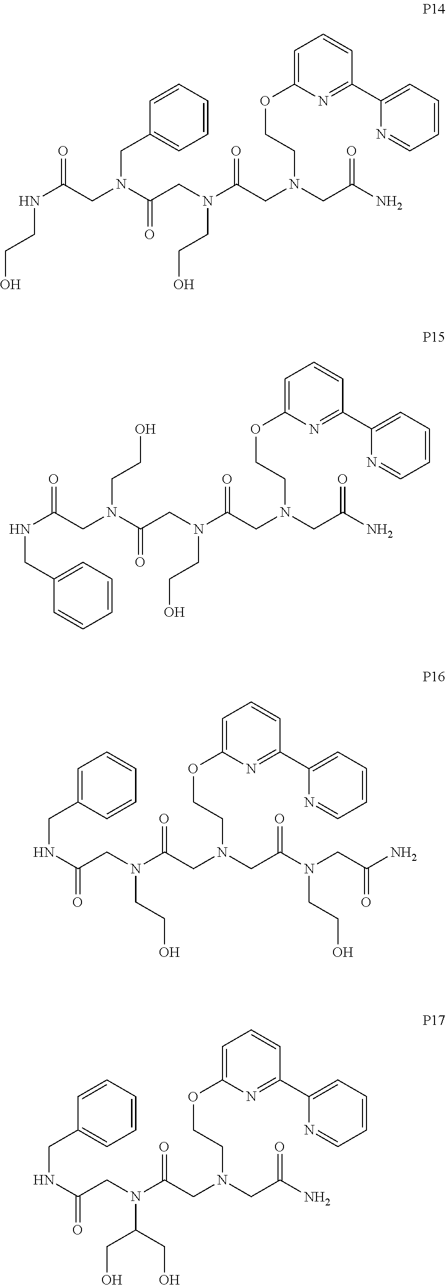 [SMILES: NC(=O)CN(CCOc1cccc(-c2ccccn2)n1)CC(=O)N(CCO)CC(=O)N(CC(=O)NCCO)Cc1ccccc1 ; NC(=O)CN(CCOc1cccc(-c2ccccn2)n1)CC(=O)N(CCO)CC(=O)N(CCO)CC(=O)NCc1ccccc1 ; NC(=O)CN(CCO)C(=O)CN(CCOc1cccc(-c2ccccn2)n1)CC(=O)N(CCO)CC(=O)NCc1ccccc1 ; NC(=O)CN(CCOc1cccc(-c2ccccn2)n1)CC(=O)N(CC(=O)NCc1ccccc1)C(CO)CO]

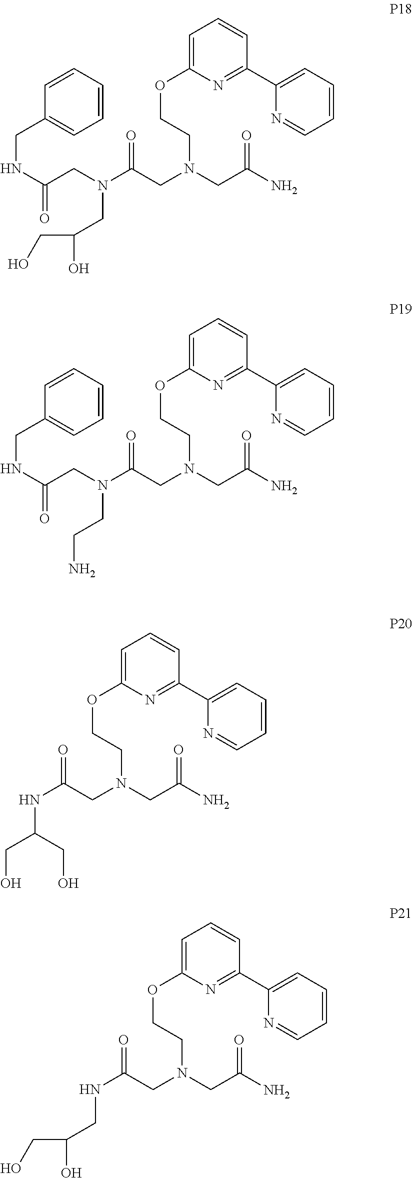 [SMILES: NC(=O)CN(CCOc1cccc(-c2ccccn2)n1)CC(=O)N(CC(=O)NCc1ccccc1)CC(O)CO ; NCCN(CC(=O)NCc1ccccc1)C(=O)CN(CCOc1cccc(-c2ccccn2)n1)CC(N)=O ; NC(=O)CN(CCOc1cccc(-c2ccccn2)n1)CC(=O)NC(CO)CO ; NC(=O)CN(CCOc1cccc(-c2ccccn2)n1)CC(=O)NCC(O)CO]

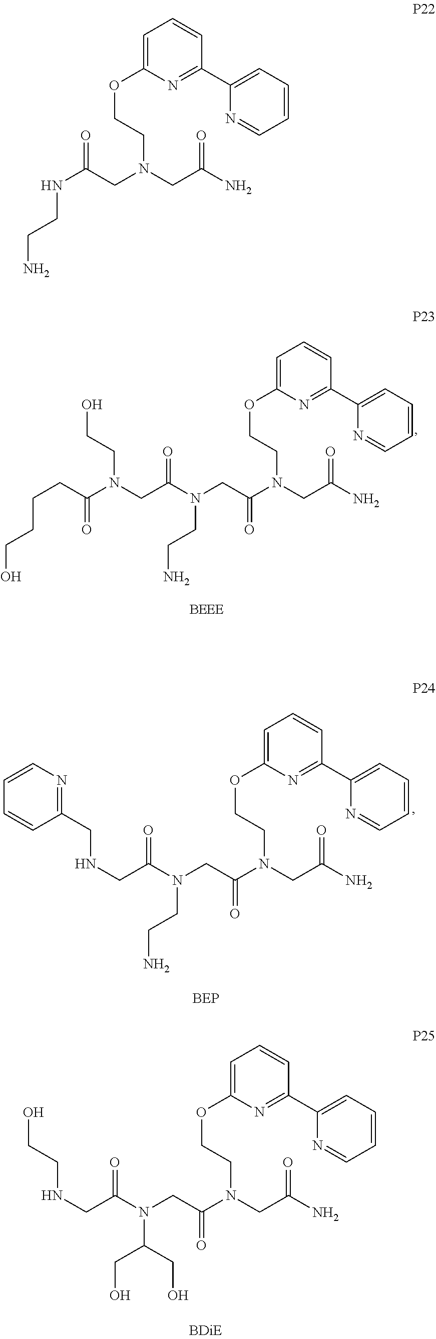 [SMILES: NCCNC(=O)CN(CCOc1cccc(-c2ccccn2)n1)CC(N)=O ; NCCN(CC(=O)N(CCOc1cccc(-c2ccccn2)n1)CC(N)=O)C(=O)CN(CCO)C(=O)CCCCO ; NCCN(CC(=O)N(CCOc1cccc(-c2ccccn2)n1)CC(N)=O)C(=O)CNCc1ccccn1 ; NC(=O)CN(CCOc1cccc(-c2ccccn2)n1)C(=O)CN(C(=O)CNCCO)C(CO)CO]

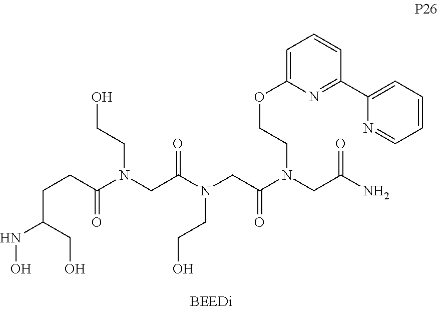 [SMILES: NC(=O)CN(CCOc1cccc(-c2ccccn2)n1)C(=O)CN(CCO)C(=O)CN(CCO)C(=O)CCC(CO)NO]

13. The medium according to claim 12, being a Cu-peptoid or a Co-Peptoid or a Mn-Peptoid.

14. The medium according to claim 1, wherein the peptoid is BEE having structure: 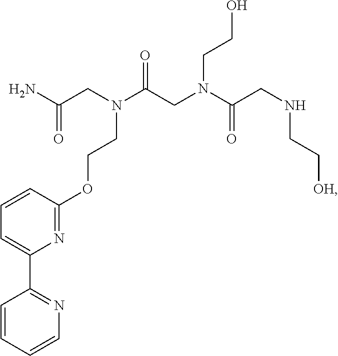 [SMILES: NC(=O)CN(CCOc1cccc(-c2ccccn2)n1)C(=O)CN(CCO)C(=O)CNCCO]
optionally associated to a copper metal ion, a manganese metal ion or a cobalt metal ion.

15. An electrocatalyst comprising or consisting a metal peptoid complex comprising at least one metal ion associated to a peptoid oligomer comprising at least one metal-binding ligand and at least one proton acceptor group, wherein the electrocatalyst is for use in a method of electrocatalysis in an aqueous medium comprising a borate species.

16. A process for water oxidation, the process comprising using a medium according to claim 1.

17. The process according to claim 16, wherein the process is carried out in an electrochemical cell comprising a cathode compartment including a cathode electrode; an anode compartment including an anode electrode comprising the electrocatalyst for oxidation reactions; wherein a water solution is supplied to the anode compartment to be electrochemically oxidized on the electrocatalyst.

18. A process for generating hydrogen gas, the process comprising treating an aqueous medium according to claim 1, under conditions permitting oxidation of the water and generation of hydrogen gas.

19. The process according to claim 18, wherein the electrocatalyst is a metal complex of BEE.

20. A device for electrolysis of water, the device comprises an electrode comprising an electrocatalyst according to claim 15, wherein the device is configured to receive and hold water containing a borate species.
